(19) United States
(12) Patent Application Publication
(10) Pub. No.: US 2023/0327838 A1
(43) Pub. Date: Oct. 12, 2023

(54) METHOD AND APPARATUS FOR MULTICAST COMMUNICATION

(71) Applicant: Telefonaktiebolaget LM Ericsson (publ), Stockholm (SE)

(72) Inventors: Rui Fan, Beijing (CN); Stefan Parkvall, Bromma (SE)

(21) Appl. No.: 18/012,678

(22) PCT Filed: Apr. 6, 2021
(86) PCT No.: PCT/CN2021/085724

§ 371 Date: Dec. 23, 2022

(30) Foreign Application Priority Data
Jun. 30, 2020 (WO) PCT/CN2020/099362

(51) Int. Cl. H04L 5/00; H04L 1/1812

(52) U.S. Cl. CPC H04L 5/0055; H04L 1/1812

(57) ABSTRACT

Various embodiments of the present disclosure provide a method for multicast communication. The method which may be performed by a terminal device comprises receiving a multicast traffic and/or a unicast traffic from a network node. The method further comprises transmitting feedback for the multicast traffic and/or the unicast traffic to the network node, according to a feedback codebook. The feedback codebook is based at least in part on a first feedback codebook type for the multicast traffic and/or a second feedback codebook type for the unicast traffic. According to various embodiments of the present disclosure, hybrid automatic repeat request feedback may be implemented efficiently and flexibly for different traffics such as multicast and unicast traffics.

### FIELD OF THE INVENTION

The present disclosure generally relates to communication networks, and more specifically, to a method and apparatus for multicast communication.

### BACKGROUND

This section introduces aspects that may facilitate a better understanding of the disclosure. Accordingly, the statements of this section are to be read in this light and are not to be understood as admissions about what is in the prior art or what is not in the prior art.

Communication service providers and network operators have been continually facing challenges to deliver value and convenience to consumers by, for example, providing compelling network services and performance. With the rapid development of networking and communication technologies, a wireless communication network, such as a long term evolution (LTE)/fourth generation (4G) network or a new radio (NR)/fifth generation (5G) network are expected to achieve high traffic capacity and end-user data rate. In order to meet different traffic requirements, the wireless communication network may be supposed to support various transmission technologies, for example, including but not limited to unicast transmission, multicast transmission, broadcast transmission, etc. For a transmitter, it may be desirable to get feedback information from a receiver to indicate whether the service data transmitted by the transmitter is received by the receiver successfully. Considering the diversity of transmission technologies and application scenarios, the feedback transmissions may become more challenging.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

Multicast/broadcast transmissions may be very useful for some applications, for example, network security public safety (NSPS), vehicle-to-everything (V2X), etc. For these applications, there may be a requirement on quality of service (QoS), e.g. less than 1% packet error rate with a delay budget of several millisecond. Therefore, it may be beneficial to support hybrid automatic repeat request (HARQ) feedback for multicast services in a wireless communication network such as 5G/NR to improve spectral efficiency.

Various exemplary embodiments of the present disclosure propose a solution for multicast communication, which can design a HARQ feedback codebook e.g. for joint multicast and unicast traffics, so that in addition or alternative to HARQ feedback information for the unicast traffic, a terminal device such as a user equipment (UE) may send HARQ feedback information for the multicast traffic to a network node efficiently and flexibly.

It can be appreciated that the term “physical carrier” described in this document refers to a radio carrier at which an unicast traffic and/or a multicast traffic may be scheduled actually, and the term “virtual carrier” described in this document refers to an imaginary carrier for a multicast traffic so that the multicast traffic which is actually scheduled at a physical carrier may be treated as from this imaginary carrier. A physical carrier may be indicated by a physical carrier index, and a virtual carrier may be indicated by a virtual carrier index.

Similarly, it can be appreciated that the term “physical slot” described in this document refers to a time slot of a physical carrier, and the term “virtual slot” described in this document refers to a time slot of a virtual carrier. A physical slot may be indicated by a physical slot number, and a virtual slot may be indicated by a virtual slot number.

According to a first aspect of the present disclosure, there is provided a method performed by a terminal device such as a UE. The method comprises receiving a multicast traffic and/or a unicast traffic from a network node. In accordance with an exemplary embodiment, the method further comprises transmitting feedback for the multicast traffic and/or the unicast traffic to the network node, according to a feedback codebook. The feedback codebook may be based at least in part on a first feedback codebook type for the multicast traffic and/or a second feedback codebook type for the unicast traffic.

In accordance with an exemplary embodiment, the first feedback codebook type and the second feedback codebook type may be both dynamic feedback codebook types.

In accordance with an exemplary embodiment, at least one of the first feedback codebook type and the second feedback codebook type may be a semi-static feedback codebook type.

In accordance with an exemplary embodiment, the feedback codebook may include a first set of bits and/or a second set of bits. The first set of bits may include one or more feedback bits determined for the multicast traffic according to the first feedback codebook type. The second set of bits may include one or more feedback bits determined for the unicast traffic according to the second feedback codebook type.

In accordance with an exemplary embodiment, the first set of bits and/or the second set of bits may be located in the feedback codebook according to a first criterion.

In accordance with an exemplary embodiment, the first criterion may include that all feedback bits of transmissions at a first carrier precede all feedback bits of transmissions at a second carrier, where an index of the first carrier is smaller than an index of the second carrier.

In accordance with an exemplary embodiment, the first criterion may include that a feedback bit of a multicast transmission at a first slot of a first carrier follows a feedback bit of a unicast transmission at the first slot of the first carrier.

In accordance with an exemplary embodiment, the first criterion may include that a feedback bit of a multicast transmission at a first slot of a first carrier precedes a feedback bit of a unicast transmission at the first slot of the first carrier.

In accordance with an exemplary embodiment, the first criterion may include that all feedback bits of transmissions at a first slot of a first carrier precede all feedback bits of transmissions at a second slot of the first carrier, where an index of the first slot is smaller than an index of the second slot.

In accordance with an exemplary embodiment, the first criterion may further include that all feedback bits of multicast transmissions at the first carrier follow all feedback bits of unicast transmissions at the first carrier.

In accordance with an exemplary embodiment, the first criterion may include that all feedback bits of multicast transmissions at a first carrier precede all feedback bits of unicast transmissions at the first carrier, while following all feedback bits of transmissions at a third carrier, where an index of the first carrier is larger than an index of the third carrier.

In accordance with an exemplary embodiment, the first criterion may include that all feedback bits of multicast transmissions precede all feedback bits of unicast transmissions.

In accordance with an exemplary embodiment, the first criterion may include that all feedback bits of multicast transmissions follow all feedback bits of unicast transmissions.

In accordance with an exemplary embodiment, the first criterion may further include that all feedback bits of multicast transmissions at a first carrier precede all feedback bits of multicast transmissions at a second carrier, where an index of the first carrier is smaller than an index of the second carrier.

In accordance with an exemplary embodiment, the first criterion may further include that a feedback bit of a multicast transmission at a first slot of a first carrier precedes a feedback bit of a multicast transmission at a second slot of the first carrier, where an index of the first slot is smaller than an index of the second slot.

In accordance with an exemplary embodiment, the terminal device may support simultaneous reception of the multicast traffic and the unicast traffic. In accordance with another exemplary embodiment, the terminal device may only support non-simultaneous reception of the multicast traffic and the unicast traffic.

In accordance with an exemplary embodiment, the feedback codebook may have a same number of one or more feedback bits as a semi-static feedback codebook which is determined for the multicast traffic or the unicast traffic.

In accordance with an exemplary embodiment, the one or more feedback bits may be located in the feedback codebook according to a second criterion.

In accordance with an exemplary embodiment, the second criterion may include that a feedback bit of a multicast transmission is located in the feedback codebook according to a slot and a carrier which are corresponding to the multicast transmission. Alternatively or additionally, the second criterion may include that a feedback bit of a unicast transmission is located in the feedback codebook according to a slot and a carrier which are corresponding to the unicast transmission.

In accordance with an exemplary embodiment, when the multicast traffic is scheduled at a physical carrier by a group-radio network temporary identifier (G-RNTI), the terminal device can determine a virtual carrier index associated with a physical carrier index of the physical carrier. The virtual carrier index may be used to indicate that the multicast traffic is treated as being scheduled at a virtual carrier associated with the physical carrier.

In accordance with an exemplary embodiment, the virtual carrier index may be corresponding to the G-RNTI and configured by radio resource control (RRC) signaling from the network node.

In accordance with an exemplary embodiment, the virtual carrier index may be determined according to one of the following criteria:
the virtual carrier index is larger than all physical carrier indexes;
the virtual carrier index is smaller than all physical carrier indexes;
the virtual carrier index is larger than the associated physical carrier index, but smaller than other physical carrier indexes which are larger than the associated physical carrier index; and
the virtual carrier index is smaller than the associated physical carrier index, but larger than other physical carrier indexes which are smaller than the associated physical carrier index.

In accordance with an exemplary embodiment, when multicast traffics are scheduled for the terminal device at two or more physical carriers, each of the two or more physical carriers may be associated with a physical carrier index and a virtual carrier index. For a physical carrier index larger than another physical carrier index, its associated virtual carrier index may be larger than another virtual carrier index associated with the another physical carrier index.

In accordance with an exemplary embodiment, when one or more other multicast traffics are also scheduled at the physical carrier by different G-RNTIs, the physical carrier index of the physical carrier may also be associated with one or more other virtual carrier indexes corresponding to the one or more other multicast traffics. For a multicast traffic scheduled by a G-RNTI smaller than another G-RNTI, the corresponding virtual carrier index may be smaller than another virtual carrier index corresponding to another multicast traffic scheduled by the another G-RNTI.

In accordance with an exemplary embodiment, when the virtual carrier index is the same as the associated physical carrier index, each slot at the virtual carrier may have a virtual slot number associated with a physical slot number of a corresponding slot at the physical carrier.

In accordance with an exemplary embodiment, the virtual slot number may be determined according to one of the following criteria:
the virtual slot number is larger than all physical slot numbers;
the virtual slot number is smaller than all physical slot numbers;
the virtual slot number is larger than the associated physical slot number, but smaller than other physical slot numbers which are larger than the associated physical slot number; and
the virtual slot number is smaller than the associated physical slot number, but larger than other physical slot numbers which are smaller than the associated physical slot number.

In accordance with an exemplary embodiment, when there are two or more virtual carriers associated with a same physical carrier, for a virtual carrier scheduled with a G-RNTI smaller than another G-RNTI, its virtual slot number may be smaller than a virtual slot number of another virtual carrier scheduled with the another G-RNTI.

In accordance with an exemplary embodiment, when frequency division multiplexing (FDM) between the unicast traffic and the multicast traffic in a same slot is not supported by the terminal device, the virtual slot number may be the same as its associated physical slot number.

In accordance with an exemplary embodiment, when FDM between different multicast traffics in a same slot is not supported by the terminal device, different virtual carriers associated with the different multicast traffics may have a same virtual slot number for the same slot.

In accordance with an exemplary embodiment, when concurrent reception of both the unicast traffic and the multicast traffic or both the multicast traffic and another multicast traffic is not supported by the terminal device in a same slot, the virtual carrier index may be the same as its associated physical carrier index.

In accordance with an exemplary embodiment, the feedback codebook may be constructed by concatenating codebooks separately constructed for the unicast traffic and the multicast traffic.

In accordance with an exemplary embodiment, the concatenation of two codebooks separately constructed for the unicast traffic and the multicast traffic may be based at least in part on a comparison between a cell-radio network temporary identifier (C-RNTI) associated with the unicast traffic and a G-RNTI associated with the multicast traffic. In an embodiment, the sequence of the two codebooks may be according to the comparison between a C-RNTI associated with the unicast traffic and a G-RNTI associated with the multicast traffic.

In accordance with an exemplary embodiment, the feedback codebook may include a first codebook for the unicast traffic followed by a second codebook for the multicast traffic.

In accordance with an exemplary embodiment, the second codebook may include one or more feedback bits, and a position of each of the one or more feedback bits may be based at least in part on a total number of feedback bits in the first codebook.

In accordance with an exemplary embodiment, when two or more codebooks for multicast traffics are concatenated in the feedback codebook, a codebook associated with a G-RNTI smaller than another G-RNTI may precede another codebook associated with the another G-RNTI.

According to a second aspect of the present disclosure, there is provided an apparatus which may be implemented as a terminal device. The apparatus may comprise one or more processors and one or more memories storing computer program codes. The one or more memories and the computer program codes may be configured to, with the one or more processors, cause the apparatus at least to perform any step of the method according to the first aspect of the present disclosure.

According to a third aspect of the present disclosure, there is provided a computer-readable medium having computer program codes embodied thereon which, when executed on a computer, cause the computer to perform any step of the method according to the first aspect of the present disclosure.

According to a fourth aspect of the present disclosure, there is provided an apparatus which may be implemented as a terminal device. The apparatus may comprise a receiving unit and a transmitting unit. In accordance with some exemplary embodiments, the receiving unit may be operable to carry out at least the receiving step of the method according to the first aspect of the present disclosure. The transmitting unit may be operable to carry out at least the transmitting step of the method according to the first aspect of the present disclosure.

According to a fifth aspect of the present disclosure, there is provided a method performed by a network node such as a base station. The method comprises transmitting a multicast traffic and/or a unicast traffic to a terminal device. In accordance with an exemplary embodiment, the method further comprises receiving feedback for the multicast traffic and/or the unicast traffic from the terminal device, according to a feedback codebook. The feedback codebook may be based at least in part on a first feedback codebook type for the multicast traffic and/or a second feedback codebook type for the unicast traffic.

In accordance with some exemplary embodiments, the feedback codebook according to the fifth aspect of the present disclosure may correspond to the feedback codebook according to the first aspect of the present disclosure. Thus, the feedback codebook according to the first aspect of the present disclosure and the feedback codebook according to the fifth aspect of the present disclosure may have the same or similar contents and/or feature elements.

In accordance with an exemplary embodiment, when the multicast traffic is scheduled at a physical carrier by a G-RNTI, the network node can determine a virtual carrier index associated with a physical carrier index of the physical carrier. The virtual carrier index may be used to indicate that the multicast traffic is treated as being scheduled at a virtual carrier associated with the physical carrier.

In accordance with some exemplary embodiments, the virtual carrier index according to the fifth aspect of the present disclosure may correspond to the virtual carrier index according to the first aspect of the present disclosure. It can be appreciated that the terminal device according to the first aspect of the present disclosure and the network node according to the fifth aspect of the present disclosure may determine the virtual carrier index based on the same or similar criterion. Similarly, it can be appreciated that the terminal device according to the first aspect of the present disclosure and the network node according to the fifth aspect of the present disclosure may determine a virtual slot number of a virtual carrier based on the same or similar criterion.

According to a sixth aspect of the present disclosure, there is provided an apparatus which may be implemented as a network node. The apparatus may comprise one or more processors and one or more memories storing computer program codes. The one or more memories and the computer program codes may be configured to, with the one or more processors, cause the apparatus at least to perform any step of the method according to the fifth aspect of the present disclosure.

According to a seventh aspect of the present disclosure, there is provided a computer-readable medium having computer program codes embodied thereon which, when executed on a computer, cause the computer to perform any step of the method according to the fifth aspect of the present disclosure.

According to an eighth aspect of the present disclosure, there is provided an apparatus which may be implemented as a network node. The apparatus may comprise a transmitting unit and a receiving unit. In accordance with some exemplary embodiments, the transmitting unit may be operable to carry out at least the transmitting step of the method according to the fifth aspect of the present disclosure. The receiving unit may be operable to carry out at least the receiving step of the method according to the fifth aspect of the present disclosure.

According to a ninth aspect of the present disclosure, there is provided a method implemented in a communication system which may include a host computer, a base station and a UE. The method may comprise providing user data at the host computer. Optionally, the method may comprise, at the host computer, initiating a transmission carrying the user data to the UE via a cellular network comprising the base station which may perform any step of the method according to the fifth aspect of the present disclosure.

According to a tenth aspect of the present disclosure, there is provided a communication system including a host computer. The host computer may comprise processing circuitry configured to provide user data, and a communication interface configured to forward the user data to a cellular network for transmission to a UE. The cellular network may comprise a base station having a radio interface and processing circuitry. The base station's processing circuitry may be configured to perform any step of the method according to the fifth aspect of the present disclosure.

According to an eleventh aspect of the present disclosure, there is provided a method implemented in a communication system which may include a host computer, a base station and a UE. The method may comprise providing user data at the host computer. Optionally, the method may comprise, at the host computer, initiating a transmission carrying the user data to the UE via a cellular network comprising the base station. The UE may perform any step of the method according to the first aspect of the present disclosure.

According to a twelfth aspect of the present disclosure, there is provided a communication system including a host computer. The host computer may comprise processing circuitry configured to provide user data, and a communication interface configured to forward user data to a cellular network for transmission to a UE. The UE may comprise a radio interface and processing circuitry. The UE's processing circuitry may be configured to perform any step of the method according to the first aspect of the present disclosure.

According to a thirteenth aspect of the present disclosure, there is provided a method implemented in a communication system which may include a host computer, a base station and a UE. The method may comprise, at the host computer, receiving user data transmitted to the base station from the UE which may perform any step of the method according to the first aspect of the present disclosure.

According to a fourteenth aspect of the present disclosure, there is provided a communication system including a host computer. The host computer may comprise a communication interface configured to receive user data originating from a transmission from a UE to a base station. The UE may comprise a radio interface and processing circuitry. The UE's processing circuitry may be configured to perform any step of the method according to the first aspect of the present disclosure.

According to a fifteenth aspect of the present disclosure, there is provided a method implemented in a communication system which may include a host computer, a base station and a UE. The method may comprise, at the host computer, receiving, from the base station, user data originating from a transmission which the base station has received from the UE. The base station may perform any step of the method according to the fifth aspect of the present disclosure.

According to a sixteenth aspect of the present disclosure, there is provided a communication system which may include a host computer. The host computer may comprise a communication interface configured to receive user data originating from a transmission from a UE to a base station. The base station may comprise a radio interface and processing circuitry. The base station's processing circuitry may be configured to perform any step of the method according to the fifth aspect of the present disclosure.

### BRIEF DESCRIPTION OF THE DRAWINGS

The disclosure itself, the preferable mode of use and further objectives are best understood by reference to the following detailed description of the embodiments when read in conjunction with the accompanying drawings, in which:

FIG. 1 is a diagram illustrating exemplary traffic transmissions according to an embodiment of the present disclosure;

FIGS. 2A-2H are diagrams illustrating exemplary HARQ codebooks according to some embodiments of the present disclosure;

FIG. 3A is a diagram illustrating exemplary traffic transmissions according to an embodiment of the present disclosure;

FIGS. 3B-3C are diagrams illustrating exemplary HARQ codebooks according to some embodiments of the present disclosure;

FIG. 4A is a diagram illustrating exemplary traffic transmissions according to an embodiment of the present disclosure;

FIG. 4B is a diagram illustrating an exemplary HARQ codebook according to an embodiment of the present disclosure;

FIG. 4C is a diagram illustrating exemplary traffic transmissions according to another embodiment of the present disclosure;

FIG. 4D is a diagram illustrating an exemplary HARQ codebook for the traffic transmissions shown in FIG. 4C;

FIG. 5A is a flowchart illustrating a method according to an embodiment of the present disclosure;

FIG. 5B is a flowchart illustrating another method according to an embodiment of the present disclosure;

FIGS. 6A-6C are block diagrams illustrating apparatuses according to some embodiments of the present disclosure;

FIG. 7 is a block diagram illustrating a telecommunication network connected via an intermediate network to a host computer in accordance with some embodiments of the present disclosure;

FIG. 8 is a block diagram illustrating a host computer communicating via a base station with a UE over a partially wireless connection in accordance with some embodiments of the present disclosure;

FIG. 9 is a flowchart illustrating a method implemented in a communication system, in accordance with an embodiment of the present disclosure;

FIG. 10 is a flowchart illustrating a method implemented in a communication system, in accordance with an embodiment of the present disclosure;

FIG. 11 is a flowchart illustrating a method implemented in a communication system, in accordance with an embodiment of the present disclosure; and

FIG. 12 is a flowchart illustrating a method implemented in a communication system, in accordance with an embodiment of the present disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “communication network” refers to a network following any suitable communication standards, such as new radio (NR), long term evolution (LTE), LTE-Advanced, wideband code division multiple access (WCDMA), high-speed packet access (HSPA), and so on. Furthermore, the communications between a terminal device and a network node in the communication network may be performed according to any suitable generation communication protocols, including, but not limited to, the first generation (1G), the second generation (2G), 2.5G, 2.75G, the third generation (3G), 4G, 4.5G, 5G communication protocols, and/or any other protocols either currently known or to be developed in the future.

The term “network node” refers to a network device in a communication network via which a terminal device accesses to the network and receives services therefrom. The network node may refer to a base station (BS), an access point (AP), a multi-cell/multicast coordination entity (MCE), a controller or any other suitable device in a wireless communication network. The BS may be, for example, a node B (NodeB or NB), an evolved NodeB (eNodeB or eNB), a next generation NodeB (gNodeB or gNB), a remote radio unit (RRU), a radio header (RH), a remote radio head (RRH), a relay, a low power node such as a femto, a pico, and so forth.

Yet further examples of the network node comprise multi-standard radio (MSR) radio equipment such as MSR BSs, network controllers such as radio network controllers (RNCs) or base station controllers (BSCs), base transceiver stations (BTSs), transmission points, transmission nodes, positioning nodes and/or the like. More generally, however, the network node may represent any suitable device (or group of devices) capable, configured, arranged, and/or operable to enable and/or provide a terminal device access to a wireless communication network or to provide some service to a terminal device that has accessed to the wireless communication network.

The term “terminal device” refers to any end device that can access a communication network and receive services therefrom. By way of example and not limitation, the terminal device may refer to a mobile terminal, a user equipment (UE), or other suitable devices. The UE may be, for example, a subscriber station, a portable subscriber station, a mobile station (MS) or an access terminal (AT). The terminal device may include, but not limited to, portable computers, image capture terminal devices such as digital cameras, gaming terminal devices, music storage and playback appliances, a mobile phone, a cellular phone, a smart phone, a tablet, a wearable device, a personal digital assistant (PDA), a vehicle, and the like.

As yet another specific example, in an Internet of things (IoT) scenario, a terminal device may also be called an IoT device and represent a machine or other device that performs monitoring, sensing and/or measurements etc., and transmits the results of such monitoring, sensing and/or measurements etc. to another terminal device and/or a network equipment. The terminal device may in this case be a machine-to-machine (M2M) device, which may in a 3rd generation partnership project (3GPP) context be referred to as a machine-type communication (MTC) device.

As one particular example, the terminal device may be a UE implementing the 3GPP narrow band Internet of things (NB-IoT) standard. Particular examples of such machines or devices are sensors, metering devices such as power meters, industrial machinery, or home or personal appliances, e.g. refrigerators, televisions, personal wearables such as watches etc. In other scenarios, a terminal device may represent a vehicle or other equipment, for example, a medical instrument that is capable of monitoring, sensing and/or reporting etc. on its operational status or other functions associated with its operation.

As used herein, the terms “first”, “second” and so forth refer to different elements. The singular forms “a” and “an” are intended to include the plural forms as well, unless the context clearly indicates otherwise. The terms “comprises”, “comprising”, “has”, “having”, “includes” and/or “including” as used herein, specify the presence of stated features, elements, and/or components and the like, but do not preclude the presence or addition of one or more other features, elements, components and/or combinations thereof. The term “based on” is to be read as “based at least in part on”. The term “one embodiment” and “an embodiment” are to be read as “at least one embodiment”. The term “another embodiment” is to be read as “at least one other embodiment”. Other definitions, explicit and implicit, may be included below.

Wireless communication networks are widely deployed to provide various telecommunication services such as voice, video, data, messaging and broadcasts. According to 3GPP Release 15 and Release 16, only unicast transmission is supported in the 5G/NR communication system. Since multicast/broadcast transmission may be very useful for some applications, e.g. NSPS, V2X, etc., a new work item (WI) is agreed to study broadcast/multicast transmission in 3GPP Release 17 for NR.

Actually multicast/broadcast may be supported in a LTE network. There are two different ways to support multicast/broadcast, i.e. single-cell point-to-multipoint (SC-PTM) or multimedia broadcast multicast service (MBMS). These approaches do not support HARQ feedback from a UE to the network. The advantage of such implementation is simplicity. The disadvantage is that the spectrum efficiency is very low. This is because the network does not know if the UE receives a packet or not. In order to ensure reliability, the network may have to use very low coding rate and may also repeat the transmission of the packet for several times.

In order to conquer this issue, it is proposed for NR to enable HARQ feedback for multicast transmission. In this case, it may be needed to consider how to transmit HARQ feedback for the multicast transmission, especially when there may be HARQ feedback for a unicast transmission and both of the multicast and unicast transmissions need to be transmitted in the same uplink (UL) slot. Since there may be two schemes to transmit HARQ feedback information bits in NR, i.e. a semi-static HARQ codebook and a dynamic HARQ codebook, both of them may need to be considered to enable a multicast HARQ feedback transmission.

Various exemplary embodiments of the present disclosure propose a solution to design a HARQ feedback codebook for a multicast service scenario where HARQ feedback information for a multicast traffic may be sent, e.g. separately from or together with HARQ feedback information for a unicast traffic. In accordance with various exemplary embodiments, some criterions may be defined so that it is clear how to determine a HARQ information bit for each unicast/multicast transmission in the HARQ feedback codebook.

In accordance with an exemplary embodiment, a general rule is that to treat a multicast traffic scheduled by a group-radio network temporary identifier (G-RNTI) as from a virtual carrier. A virtual carrier index of this virtual carrier may be either explicitly configured by radio resource control (RRC) signaling, or implicitly predefined.

For the case of configuring a virtual carrier index explicitly, the virtual carrier index may be linked to the G-RNTI that is used to schedule the multicast traffic. In an embodiment, one G-RNTI has one unique virtual carrier index.

For the case of configuring a virtual carrier index implicitly, any of the following criteria may be predefined to determine the virtual carrier index:
The virtual carrier index is larger than all physical carrier indexes.
The virtual carrier index is smaller than all physical carrier indexes.
The virtual carrier index is larger than its associated physical carrier index but smaller than other physical carrier indexes which are larger than its associated physical carrier index.
The virtual carrier index is smaller than its associated physical carrier index but larger than other physical carrier indexes which are smaller than its associated physical carrier index.
When there are more than one virtual carriers and each virtual carrier is associated with a different physical carrier, a virtual carrier which is associated with a physical carrier with a smaller index also has a smaller index compared to another virtual carrier associated with a physical carrier with a larger index.
When there are more than one virtual carriers associated to the same physical carrier, a virtual carrier scheduled with a smaller G-RNTI has a smaller carrier index compared to another virtual carrier scheduled with a lager G-RNTI.
The virtual carrier index is the same as its associated physical carrier. In this case, a slot number of the virtual carrier may be determined according to any of the following criteria:
   The slot number of the virtual carrier is larger than all physical carrier slot numbers.
   The slot number of the virtual carrier is smaller than all physical carrier slot numbers.
   The slot number of the virtual carrier is larger than its associated physical carrier slot number but small than other physical carrier slot numbers which are larger than its associated physical slot number.
   The slot number of the virtual carrier is smaller than its associated physical slot number but larger than other physical carrier slot numbers which are smaller than its associated physical slot number.
   When there are more than one virtual carrier associated with same physical carrier, a virtual carrier scheduled with a smaller G-RNTI has a smaller slot number compared to another virtual carrier scheduled with a larger G-RNTI.
   When a UE does not support frequency division multiplexing (FDM) between unicast and multicast traffics in a same slot, a slot number of a virtual carrier is the same as that of the corresponding physical carrier slot.
   When a UE does not support FDM between different multicast traffics in a same slot, the slot numbers of different virtual carriers for the multicast traffics are the same for the same slot.

According to an exemplary embodiment, if a UE does not support concurrent reception of both unicast and multicast traffics, a multicast transmission may be treated as a normal unicast transmission in the same slot and from the same physical carrier. Then the rule to determine a HARQ codebook as defined in 3GPP Release 15/Release16 for NR may be applied. For example, a semi-static HARQ codebook may be designed as described in section 9.1.2 of 3GPP technical specification (TS) 38.213 V16.1.0 (where the entire content of this technical specification is incorporated into the present disclosure by reference), and a dynamic HARQ codebook may be designed as described in section 9.1.3 of 3GPP TS 38.213 V16.1.0.

According to another exemplary embodiment, if a UE does not support concurrent reception of both unicast and multicast traffics, or different multicast traffics in one slot, a virtual carrier index of a virtual carrier for a multicast traffic may be the same as that of its associated physical carrier where the multicast traffic is transmitted. Then the rule to determine a HARQ codebook as defined in 3GPP Release 15/Release16 for NR may be applied.

According to another exemplary embodiment, if a UE can support concurrent reception of both unicast and multicast traffics, a multicast transmission from a physical carrier Cᵢ (i=1, 2, . . . , n) may be treated as a transmission from a virtual carrier C_{i′}. Then the rule to determine a HARQ codebook as defined in 3GPP Release 15/Release 16 for NR may be applied based at least in part on the actual carrier indexes of unicast transmissions and/or the virtual carrier indexes of multicast transmissions, e.g. according to one or more of the following predetermined criterions:
criterion (i): the carrier index C_{i′} of the virtual carrier may be considered as the same as its corresponding physical carrier Cᵢ (i.e. Cᵢ=C_{i′}), while the slot number of the multicast transmission at the virtual carrier C_{i′} may be considered to be larger than the slot number of the concurrently received unicast transmission at the physical carrier Cᵢ;
criterion (ii): the carrier index C_{i′} of the virtual carrier may be considered as the same as its corresponding physical carrier Cᵢ (i.e. Cᵢ=C_{i′}), while the slot number of the multicast transmission at the virtual carrier C_{i′} may be considered to be smaller than the slot number of the concurrently received unicast transmission at the physical carrier Cᵢ;
criterion (iii): the carrier index C_{i′} of the virtual carrier may be considered to be larger than that of its corresponding physical carrier Cᵢ but smaller than all other carrier indexes which are larger than the physical carrier index Cᵢ, e.g., Cᵢ<C_{i′}<Cᵢ₊₁< . . . <Cₙ;
criterion (iv): the carrier index C_{i′} of the virtual carrier may be considered to be smaller than that of its corresponding physical carrier Cᵢ but larger than all other carrier indexes which are smaller than the physical carrier index Cᵢ, e.g. C₁< . . . <Cᵢ₋₁<C_{i′}<Cᵢ;
criterion (v): the carrier index C_{i′} of the virtual carrier may be considered to be larger than all physical carrier indexes, e.g. C₁<C₂< . . . <Cₙ<C_{i′}; and
criterion (vi): the carrier index C_{i′} of the virtual carrier may be considered to be smaller than all physical carrier indexes, e.g. C_{i′}<C₁<C₂< . . . <Cₙ;
criterion (vii): the HARQ bits of multicast/unicast transmissions may be located in a HARQ codebook according to a specific order (e.g. descending or ascending) of carrier indexes of the multicast/unicast transmissions; and
criterion (viii): for each carrier, the HARQ bits of multicast/unicast transmissions may be located in a HARQ codebook according to a specific order (e.g. descending or ascending) of slot numbers of the multicast/unicast transmissions.

As mentioned previously, there may be two different types of HARQ feedback codebooks (i.e. semi-static HARQ feedback codebook and dynamic HARQ feedback codebook) to send HARQ feedback for a unicast traffic, as described in 3GPP Release 15/Release16 for NR. In accordance with an exemplary embodiment, the two types of HARQ codebooks may be used to support HARQ feedback for a multicast traffic as well. In this case, according to whether a dynamic HARQ feedback codebook and/or a semi-static HARQ feedback codebook is configured for multicast and unicast traffics, there may be the following four scenarios:
scenario I: both multicast and unicast traffics are configured to use the semi-static HARQ feedback codebook;
scenario II: the multicast traffic is configured to use the semi-static HARQ feedback codebook, and the unicast traffic is configured to use the dynamic HARQ feedback codebook;
scenario III: the multicast traffic is configured to use the dynamic HARQ feedback codebook, and the unicast traffic is configured to use the semi-static HARQ feedback codebook; and
scenario IV: both multicast and unicast traffics are configured to use the dynamic HARQ feedback codebook.

For each of the above scenarios, there may be two cases that may have impact on the criterion to determine the HARQ feedback codebook, including:
case A: a UE may support concurrent reception of unicast and multicast traffics; and
case B: a UE does not support concurrent reception of unicast and multicast traffics.

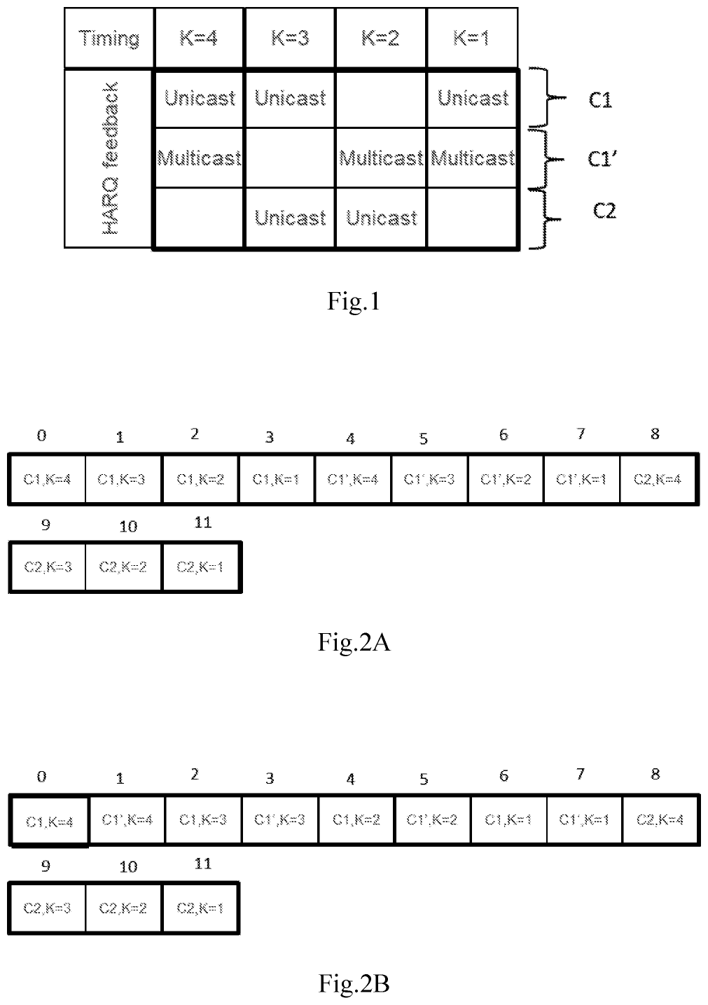

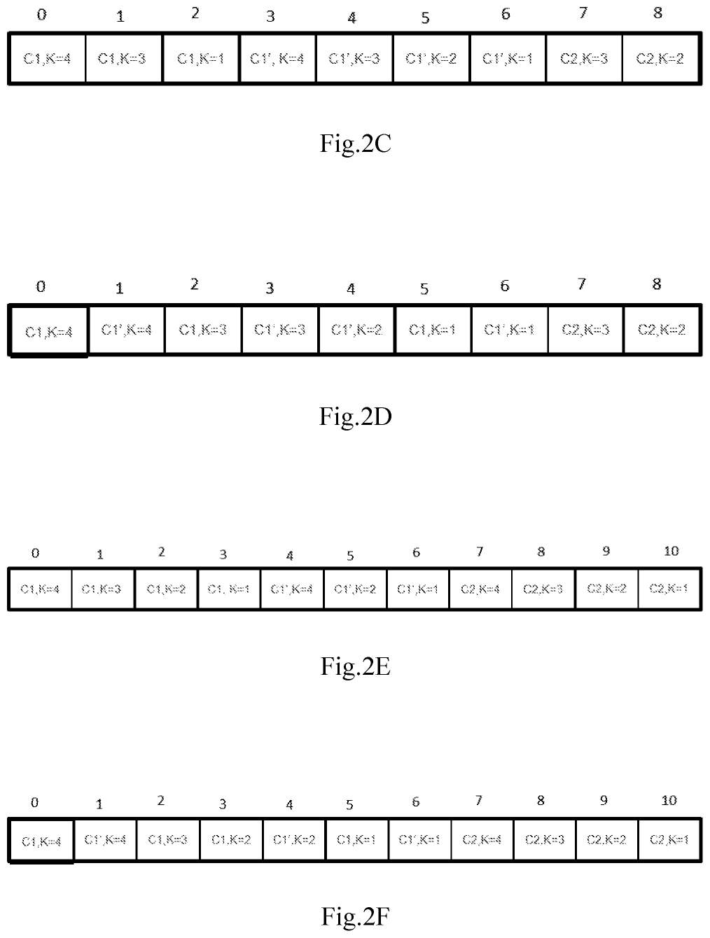

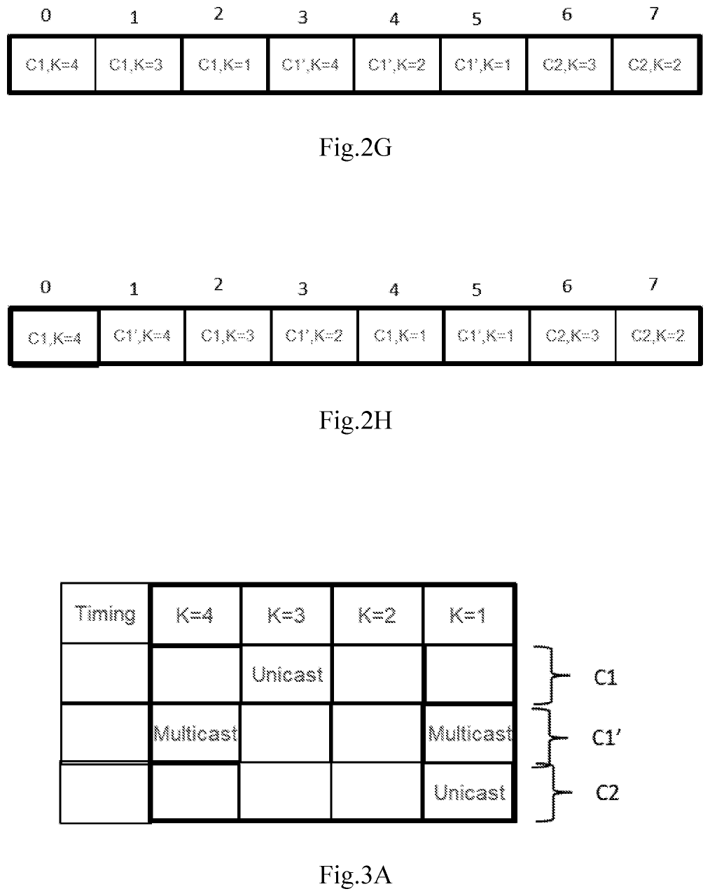

The HARQ feedback codebook design for multicast and/or unicast traffics in different scenarios will be described below with reference to FIG. 1, FIGS. 2A-2H, FIGS. 3A-3C and FIGS. 4A-4B.

FIG. 1 is a diagram illustrating exemplary traffic transmissions according to an embodiment of the present disclosure. This embodiment may be applicable for case A where a UE may support simultaneous reception of multicast and unicast traffics in a carrier. As shown in FIG. 1, the UE may be scheduled at three slots respectively corresponding to K=4, K=3 and K=1 for its own unicast traffic in carrier C1, and at two slots respectively corresponding to K=3 and K=2 for its own unicast traffic in carrier C2, where K is used to indicate the relative number of slots from downlink scheduling to its corresponding uplink feedback. In addition, the UE may also be scheduled at three slots respectively corresponding to K=4, K=2 and K=1 for a multicast traffic in carrier C1. In accordance with some exemplary embodiments, different types of HARQ codebooks may be determined for the UE according to different cases in various scenarios.

According to an embodiment for case A in scenario I, a multicast transmission in a physical carrier Cᵢ may be treated as from a virtual carrier C_{i′}. In this case, the total number of HARQ bits in a HARQ codebook for one carrier may be twice as that with just unicast traffic. The location of a HARQ bit of multicast/unicast transmission at carrier Cᵢ in the HARQ codebook may be arranged in accordance with a predetermined criterion, e.g. criterions (i)˜(viii) as mentioned previously or any other suitable criterions.

FIGS. 2A-2B are diagrams illustrating exemplary HARQ codebooks for case A in scenario I according to some embodiments of the present disclosure. For the traffic transmissions for the UE as shown in FIG. 1, in an embodiment using criterion (iii), the location of a HARQ bit of multicast transmission at carrier C1 (e.g. a multicast HARQ bit used for K=4 at C1′) in the HARQ codebook may follow all the HARQ bits of unicast transmissions at carrier C1 (e.g. unicast HARQ bits used for K=4, K=3, K=2 and K=1 at C1), assuming the index of virtual carrier C1′ is larger than that of the actual carrier C1 but smaller than all other carrier indexes which are larger than C1, e.g. C1<C1′<C2, as shown in FIG. 2A. In another embodiment using criterion (i), the location of a HARQ bit of multicast transmission at carrier C1 (e.g. a multicast HARQ bit used for K=4 at C1′) in the HARQ codebook may follow a HARQ bit of unicast transmission at the same slot of carrier C1 (e.g. a unicast HARQ bit used for K=4 at C1), assuming the index of virtual carrier C1′ is the same as the actual carrier C, i.e. C1=C1′, as shown in FIG. 2B.

According to an embodiment for case A in scenario II, a multicast transmission in a physical carrier Cᵢ may be treated as from a virtual carrier C_{i′}. In this case, the total number of HARQ bits in a HARQ codebook may be the sum of bits in a semi-static HARQ codebook determined for a multicast traffic and a dynamic HARQ codebook determined for a unicast traffic. The location of a HARQ bit of multicast transmission at carrier Cᵢ in the HARQ codebook may be arranged in accordance with a predetermined criterion, e.g. criterions (i)˜(viii) as mentioned previously or any other suitable criterions.

FIGS. 2C-2D are diagrams illustrating exemplary HARQ codebooks for case A in scenario II according to some embodiments of the present disclosure. For the traffic transmissions for the UE as shown in FIG. 1, in an embodiment using criterion (iii), the location of a HARQ bit of multicast transmission at carrier C1 (e.g. a multicast HARQ bit used for K=4 at C1′) in the codebook may follow all the HARQ bits of unicast transmission at carrier C1 (e.g. unicast HARQ bits used for K=4, K=3 and K=1 at C1), assuming the index of virtual carrier C1′ is larger than that of the actual carrier C1 but smaller than all other carrier indexes which are larger than C1, e.g. C1<C1′<C2, as shown in FIG. 2C. In another embodiment using criterion (i), the location of a HARQ bit of multicast transmission at carrier C1 (e.g. a multicast HARQ bit used for K=4 at C1′) in the codebook may follow a HARQ bit of unicast transmission at the same slot of carrier C1 (e.g. a unicast HARQ bit used for K=4 at C1), assuming the index of virtual carrier C1′ is the same as the actual carrier C1, i.e. C1=C1′, as shown in FIG. 2D.

According to an embodiment for case A in scenario III, a multicast transmission in a physical carrier Cᵢ may be treated as from a virtual carrier C_{i′}. In this case, the total number of HARQ bits in a HARQ codebook may be the sum of bits in a semi-static HARQ codebook determined for a unicast traffic and a dynamic HARQ codebook determined for a multicast traffic. The location of a HARQ bit of multicast transmission at carrier Cᵢ in the HARQ codebook may be arranged in accordance with a predetermined criterion, e.g. criterions (i)˜(viii) as mentioned previously or any other suitable criterions.

FIGS. 2E-2F are diagrams illustrating exemplary HARQ codebooks for case A in scenario III according to some embodiments of the present disclosure. For the traffic transmissions for the UE as shown in FIG. 1, in an embodiment using criterion (iii), the location of a HARQ bit of multicast transmission at carrier C1 (e.g. a multicast HARQ bit used for K=4 at C1′) in the codebook may follow all the HARQ bits of unicast transmission at carrier C1 (e.g. unicast HARQ bits used for K=4, K=3, K=2 and K=1 at C1), assuming the index of virtual carrier C1′ is larger than that of the actual carrier C1 but smaller than all other carrier indexes which are larger than C1, e.g. C1<C1′<C2, as shown in FIG. 2E. In another embodiment using criterion (i), the location of a HARQ bit of multicast transmission at carrier C1 (e.g. a multicast HARQ bit used for K=4 at C1′) in the codebook may follow a HARQ bit of unicast transmission at the same slot of carrier C1 (e.g. a unicast HARQ bit used for K=4 at C1), assuming the index of virtual carrier C1′ is the same as the actual carrier C1, i.e. C1=C1′, as shown in FIG. 2F.

According to an embodiment for case A in scenario IV, a multicast transmission in a physical carrier Cᵢ may be treated as from a virtual carrier C_{i′}. In this case, the total number of HARQ bits in a HARQ codebook may be the sum of bits in a dynamic HARQ codebook determined for a unicast traffic and a dynamic HARQ codebook determined for a multicast traffic. The location of a HARQ bit of multicast transmission at carrier Cᵢ in the HARQ codebook may be arranged in accordance with a predetermined criterion, e.g. criterions (i)˜(viii) as mentioned previously or any other suitable criterions.

FIGS. 2G-2H are diagrams illustrating exemplary HARQ codebooks for case A in scenario IV according to some embodiments of the present disclosure. For the traffic transmissions for the UE as shown in FIG. 1, in an embodiment using criterion (iii), the location of a HARQ bit of multicast transmission at carrier C1 (e.g. a multicast HARQ bit used for K=4 at C1′) in the codebook may follow all the HARQ bits of unicast transmission at carrier C1 (e.g. unicast HARQ bits used for K=4, K=3 and K=1 at C1), assuming the index of virtual carrier C1′ is larger than that of the actual carrier C1 but smaller than all other carrier indexes which are larger than C1, e.g. C1<C1′<C2, as shown in FIG. 2G. In another embodiment using criterion (i), the location of a HARQ bit of multicast transmission at carrier C1 (e.g. a multicast HARQ bit used for K=4 at C1′) in the codebook may follow a HARQ bit of unicast transmission at the same slot of carrier C1 (e.g. a unicast HARQ bit used for K=4 at C1), assuming the index of virtual carrier C1′ is the same as actual carrier C1, i.e. C1=C1′, as shown in FIG. 2H.

It can be appreciated that although exemplary embodiments for case A are mainly described for criterions (i) and (iii), other suitable criterions (e.g. criterions (ii), (iv), (v), (vi), (vii) and/or (viii), etc.) may also be used to determine a HARQ codebook for a UE in case A. In accordance with some exemplary embodiments, one or more of criterions (i)˜(viii) may be used to determine a HARQ codebook for a UE in case B as well. In this case, a unicast traffic and a multicast traffic may both have their own HARQ bits in the HARQ codebook, for example, in a specific order of the carrier index and/or the slot index of unicast/multicast transmission.

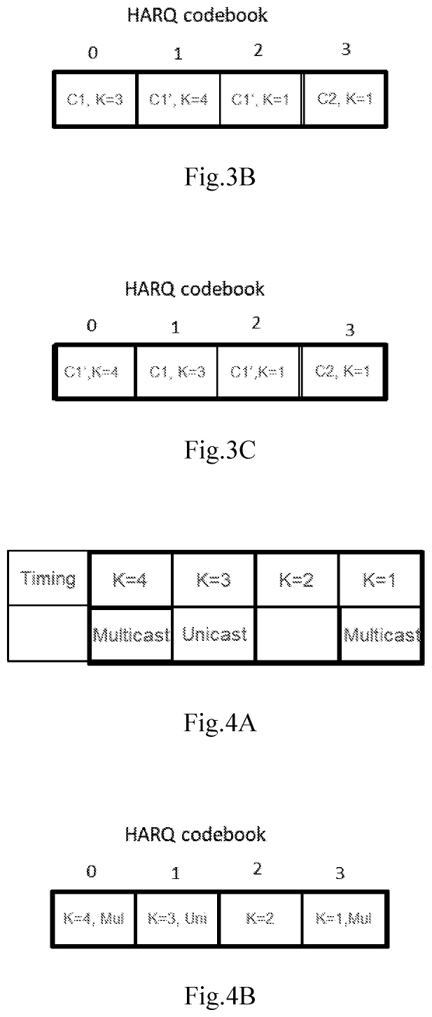

FIG. 3A is a diagram illustrating exemplary traffic transmissions according to an embodiment of the present disclosure. This embodiment may be applicable for case B where a UE does not support simultaneous reception of multicast and unicast traffics in a carrier. As shown in FIG. 3A, the UE may be scheduled at a slot corresponding to K=3 for its own unicast traffic in carrier C1, and at a slot corresponding to K=1 for its own unicast traffic in carrier C2. In addition, the UE may also be scheduled at two slots respectively corresponding to K=4 and K=1 for a multicast traffic in carrier C1. In accordance with exemplary embodiments, different types of HARQ codebooks may be determined for the UE according to different cases in various scenarios.

According to an embodiment for case B in scenario IV, a multicast transmission in a physical carrier C1 may be treated as from a virtual carrier C_{i′}. In this case, the total number of HARQ bits in a HARQ codebook may be the sum of bits in a dynamic HARQ codebook determined for a unicast traffic and a dynamic HARQ codebook determined for a multicast traffic. The location of a HARQ bit of multicast transmission at carrier Cᵢ in the HARQ codebook may be arranged in accordance with the following criterion (ix) or any other suitable criterion, e.g. criterions (iii)˜(viii) as mentioned previously.
criterion (ix): the carrier index C_{i′}, of the virtual carrier may be considered as the same as its corresponding physical carrier Cᵢ (i.e. Cᵢ=C_{i′}).

FIGS. 3B-3C are diagrams illustrating exemplary HARQ codebooks for case B in scenario IV according to some embodiments of the present disclosure. For the traffic transmissions for the UE as shown in FIG. 3A, in an embodiment using criterion (iii), the location of a HARQ bit of multicast transmission at carrier C1 (e.g. a multicast HARQ bit used for K=4 at C1′) in the codebook may follow all the HARQ bits of unicast transmission at carrier C1 (e.g. a unicast HARQ bit used for K=3 at C1), assuming the index of virtual carrier C1′ is larger than that of the actual carrier C1 but smaller than all other carrier indexes which are larger than C1, e.g. C1<C1′<C2, as shown in FIG. 3B. In another embodiment using criterion (ix), the location of a HARQ bit of multicast transmission at slot Tⱼ (j=1, 2, . . . , m) of carrier C1 (e.g. a multicast HARQ bit used for K=4 at C1′) in the codebook may precede a HARQ bit of other transmission (e.g. unicast or multicast transmission) in carrier C1 with a slot number larger than Tⱼ (e.g. a unicast HARQ bit used for K=3 at C1), assuming the index of virtual carrier C1′ is the same as the actual carrier C1, i.e. C1=C1′, as shown in FIG. 3C.

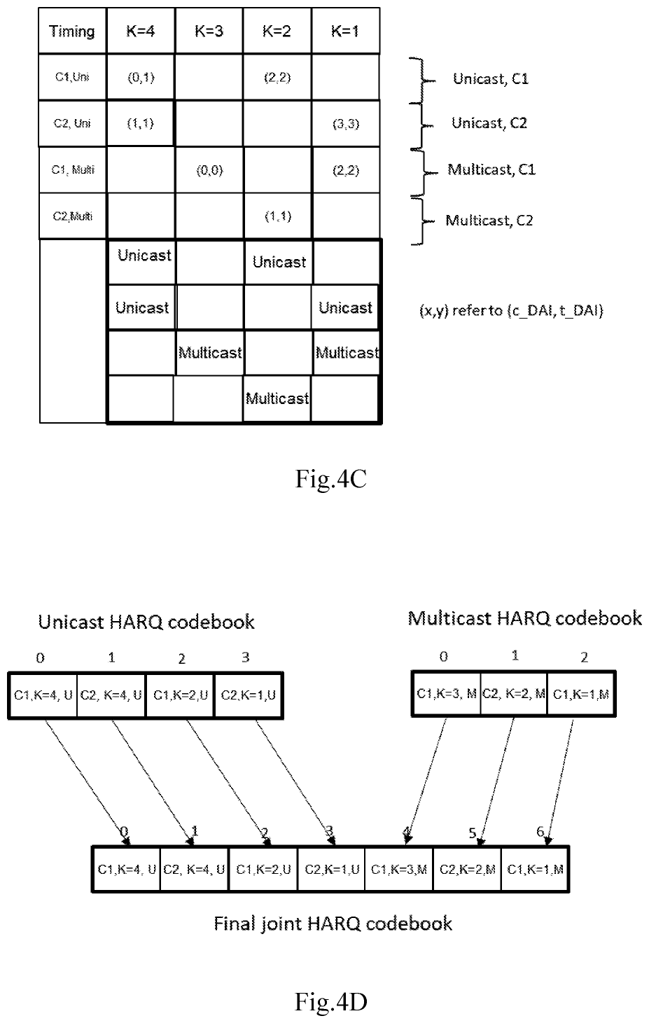

FIG. 4A is a diagram illustrating exemplary traffic transmissions according to an embodiment of the present disclosure. This embodiment may be applicable for case B where a UE does not support simultaneous reception of multicast and unicast traffics in a carrier. As shown in FIG. 4A, the UE may be scheduled at a slot corresponding to K=3 for its own unicast traffic, and at two slots respectively corresponding to K=4 and K=1 for a multicast traffic. In accordance with exemplary embodiments, different types of HARQ codebooks may be determined for the UE according to different cases in various scenarios.

According to some exemplary embodiments for case B in scenarios I, II and III, a multicast transmission in a slot at a carrier may be treated as a unicast transmission in the same slot at the same carrier. In an embodiment, the number of HARQ bits in a HARQ codebook may be the same as that of a semi-static HARQ codebook when there is just unicast transmission. The location of a HARQ bit of multicast transmission in the HARQ codebook may be arranged in accordance with the following criterion (x) or any other suitable criterion.
criterion (x): the location of a HARQ bit of multicast transmission in slot Tⱼ at carrier Cᵢ in the HARQ codebook may be the same as that if there is a unicast transmission in the same slot Tⱼ from the same carrier Cᵢ.

FIG. 4B is a diagram illustrating an exemplary HARQ codebook for case B in scenario I according to an embodiment of the present disclosure. For the traffic transmissions for the UE as shown in FIG. 4A, in an embodiment using criterion (x), the location of a HARQ bit of multicast/unicast transmission at slot Tⱼ in the codebook may be arranged in an ascending order of slot number/index, e.g. a HARQ bit used for multicast transmission at a slot corresponding to K=4 may precede a HARQ bit used for unicast transmission at a slot corresponding to K=3, as shown in FIG. 4B.

According to an exemplary embodiment, for dynamic codebook construction, the respective codebooks for unicast and multicast HARQ feedback, e.g., a unicast codebook and a multicast codebook, may be firstly constructed separately and then concatenated together to form the final feedback codebook. In an embodiment, the concatenation sequence of the separate codebooks may be according to a result of comparison between a C-RNTI associated with the unicast traffic and a G-RNTI associated with the multicast traffic. In another embodiment, the multicast codebook may just follow the end of the unicast codebook. As a UE knows the total number of unicast HARQ bits of the unicast codebook, the multicast HARQ bit position in the multicast codebook may be determined according to the original position calculated for the multicast HARQ bit in the multicast codebook constructed separately and the total number of unicast HARQ bits of the unicast codebook. If more than one multicast codebook needs to be concatenated in the final feedback codebook, a multicast codebook linked to a smaller G-RNTI may precede another multicast codebook linked to a larger G-RNTI.

In accordance with an exemplary embodiment, the multicast HARQ bit position in the multicast codebook is its original calculated position in the separately constructed multicast codebook plus the total number of unicast HARQ bits of the unicast codebook. For example, assuming that: (i) the unicast HARQ bit position in a separate unicast codebook is O′_1, O′_2, ..., 0′_N′, where N′ is the total number of bits in the unicast codebook; (ii) the multicast HARQ bit position in a first separate multicast codebook linked to a smaller G-RNTI G1 may be O″_1, O″_2, . . . , 0″_N″, where N″ is the total number of bits in the first multicast codebook; and (iii) the multicast HARQ bit position in a second separate multicast codebook linked to a larger G-RNTI G2 (where G2>G1) may be O′″_1, O′″_2, . . . , 0′″_N′″, where N′″ is the total number of bits in the second multicast codebook; then the position O_i of ith HARQ information bit in the final feedback codebook which is constructed by concatenating the unicast codebook, the first multicast codebook and the second multicast codebook may be determined as below:

O_i=O′_i, when 0<i<=N′ (1)

O_i=O″_i+N′, when N′<i<=N′+N″ (2)

O_i=O′″_i+N′+N″, when N′+N″<i<=N′+N″+N′″ (3)

FIG. 4C is a diagram illustrating exemplary traffic transmissions according to another embodiment of the present disclosure. As shown in FIG. 4C, a network node such as a gNB may schedule both unicast and multicast traffics for a UE over two carriers C1 and C2, where at a slot corresponding to K=4, the unicast traffic is scheduled via both C1 and C2, at a slot corresponding to K=3, the multicast traffic is scheduled via C1, at a slot corresponding to K=2, the unicast traffic is scheduled via C1 and the multicast traffic is scheduled via C2, and finally at a slot corresponding to K=1, the unicast traffic is scheduled via C2 and the multicast traffic is scheduled via C1. In an embodiment, a dynamic codebook may be configured for the unicast and multicast traffics of the UE. Therefore, at each downlink slot, downlink control information (DCI) for the UE may need to use a downlink assignment indicator (DAI) to indicate the number of scheduled data, e.g., by using a parameter (x, y)=(c_DAI, t_DAI), where c_DAI is the counter DAI and t_DAI is the total DAI. The unicast DAI and the multicast DAI may be counted separately. As an example, the parameter (x, y)=(c_DAI, t_DAI) for the unicast traffic over carrier C1 at a slot corresponding to K=4 is represented by (0, 1), and the parameter (x, y)=(c_DAI, t_DAI) for the multicast traffic over carrier C1 at a slot corresponding to K=1 is represented by (2, 2), etc., as shown in FIG. 4C.

FIG. 4D is a diagram illustrating an exemplary HARQ codebook for the traffic transmissions shown in FIG. 4C. The exemplary HARQ codebook may be constructed by jointing a unicast HARQ codebook and a multicast HARQ codebook separately constructed for unicast and multicast traffics scheduled over carrier C1 and C2 as shown in FIG. 4C. Firstly, the unicast traffics and the multicast traffics may each construct its own codebook separately according to its own DAI, e.g., by using a dynamic codebook construction rule or criterion according to various exemplary embodiments. For example, as shown in FIG. 4D, in total there are 4 bits in the unicast HARQ codebook and 3 bits in the multicast HARQ codebook. Secondly, the final joint HARQ codebook may be constructed by appending the multicast HARQ codebook to the unicast HARQ codebook. Therefore, 4 unicast HARQ feedback bits occupy positions 0˜3 and 3 multicast HARQ feedback bits occupy positions 4˜6 in the final joint HARQ codebook.

It is noted that some embodiments of the present disclosure are mainly described in relation to 4G/LTE or 5G/NR specifications being used as non-limiting examples for certain exemplary network configurations and system deployments. As such, the description of exemplary embodiments given herein specifically refers to terminology which is directly related thereto. Such terminology is only used in the context of the presented non-limiting examples and embodiments, and does naturally not limit the present disclosure in any way. Rather, any other system configuration or radio technologies may equally be utilized as long as exemplary embodiments described herein are applicable.

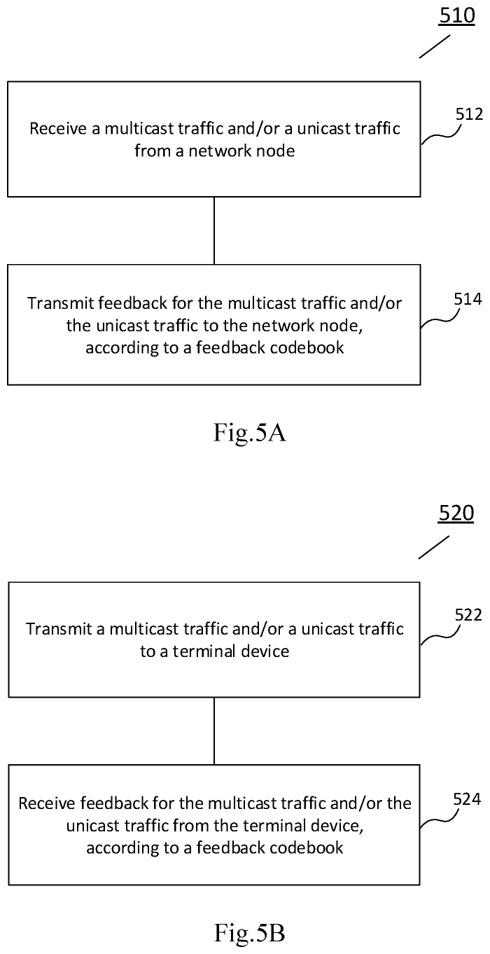

FIG. 5A is a flowchart illustrating a method 510 according to some embodiments of the present disclosure. The method 510 illustrated in FIG. 5A may be performed by a terminal device or an apparatus communicatively coupled to the terminal device. In accordance with an exemplary embodiment, the terminal device such as a UE may be configured to get various traffics (e.g., a unicast traffic, a multicast traffic, etc.) from a network node such as a gNB, and send HARQ feedback for the unicast/multicast traffic to the network node.

According to the exemplary method 510 illustrated in FIG. 5A, the terminal device may receive a multicast traffic and/or a unicast traffic from a network node, as shown in block 512. In accordance with an exemplary embodiment, the terminal device may transmit feedback for the multicast traffic and/or the unicast traffic to the network node, according to a feedback codebook, as shown in block 514. The feedback codebook may be based at least in part on a first feedback codebook type for the multicast traffic and/or a second feedback codebook type for the unicast traffic. In an embodiment, the first feedback codebook type and the second feedback codebook type may be both dynamic feedback codebook types. In another embodiment, at least one of the first feedback codebook type and the second feedback codebook type may be a semi-static feedback codebook type.

In accordance with an exemplary embodiment, the feedback codebook may include a first set of bits and/or a second set of bits. The first set of bits may include one or more feedback bits determined for the multicast traffic according to the first feedback codebook type, and the second set of bits may include one or more feedback bits determined for the unicast traffic according to the second feedback codebook type. According to an exemplary embodiment, the first set of bits and/or the second set of bits may be located in the feedback codebook according to a first criterion.

In accordance with an exemplary embodiment, the first criterion may include one or more of the following elements:
all feedback bits of transmissions at a first carrier precede all feedback bits of transmissions at a second carrier, where an index of the first carrier is smaller than an index of the second carrier, e.g. as shown in FIGS. 2A-2H and FIGS. 3B-3C;
a feedback bit of a multicast transmission at a first slot of a first carrier follows a feedback bit of a unicast transmission at the first slot of the first carrier, e.g. as shown in FIG. 2B, FIG. 2D, FIG. 2F and FIG. 2H;
a feedback bit of a multicast transmission at a first slot of a first carrier precedes a feedback bit of a unicast transmission at the first slot of the first carrier;
all feedback bits of transmissions at a first slot of a first carrier precede all feedback bits of transmissions at a second slot of the first carrier, where an index of the first slot is smaller than an index of the second slot, e.g. as shown in FIG. 2B, FIG. 2D, FIG. 2F, FIG. 2H, FIG. 3C and FIG. 4B;
all feedback bits of multicast transmissions at the first carrier follow all feedback bits of unicast transmissions at the first carrier, e.g. as shown in FIG. 2A, FIG. 2C, FIG. 2E, FIG. 2G and FIG. 3B;
all feedback bits of multicast transmissions at a first carrier precede all feedback bits of unicast transmissions at the first carrier, while following all feedback bits of transmissions at a third carrier, where an index of the first carrier is larger than an index of the third carrier;
all feedback bits of multicast transmissions precede all feedback bits of unicast transmissions;
all feedback bits of multicast transmissions follow all feedback bits of unicast transmissions;
all feedback bits of multicast transmissions at a first carrier precede all feedback bits of multicast transmissions at a second carrier, where an index of the first carrier is smaller than an index of the second carrier; and
a feedback bit of a multicast transmission at a first slot of a first carrier precedes a feedback bit of a multicast transmission at a second slot of the first carrier, where an index of the first slot is smaller than an index of the second slot, e.g. as shown in FIGS. 2A-2H, FIGS. 3B-3C and FIG. 4B.

In accordance with an exemplary embodiment, the terminal device may support simultaneous reception of the multicast traffic and the unicast traffic. In accordance with another exemplary embodiment, the terminal device may only support non-simultaneous reception of the multicast traffic and the unicast traffic. In the latter case, the feedback codebook may have a same number of one or more feedback bits as a semi-static feedback codebook which is determined for the multicast traffic or the unicast traffic. According to an exemplary embodiment, the one or more feedback bits may be located in the feedback codebook according to a second criterion.

In accordance with an exemplary embodiment, the second criterion may include one or more of the following elements:
a feedback bit of a multicast transmission is located in the feedback codebook according to a slot and a carrier which are corresponding to the multicast transmission (e.g. in descending order of the slot index per carrier as shown in FIG. 4B or according to other appropriate sorting rules); and
a feedback bit of a unicast transmission is located in the feedback codebook according to a slot and a carrier which are corresponding to the unicast transmission (e.g. in descending order of the slot index per carrier as shown in FIG. 4B or according to other appropriate sorting rules).

In accordance with an exemplary embodiment, the second criterion may further include that: the location of a feedback bit of a multicast transmission at slot Tⱼ from carrier Cᵢ in the feedback codebook may be the same as that if there is a unicast transmission in the same slot Tⱼ from the same carrier Cᵢ. In an embodiment, the multicast feedback bits and the unicast feedback bits in the feedback codebook may be arranged according to the same sorting rule, for example, in ascending order of the carrier index, and in ascending order of the slot index per carrier, etc.

In accordance with an exemplary embodiment, when the multicast traffic is scheduled at a physical carrier by a G-RNTI, the terminal device can determine a virtual carrier index associated with a physical carrier index of the physical carrier. The virtual carrier index may be used to indicate that the multicast traffic is treated as being scheduled at a virtual carrier associated with the physical carrier.

In accordance with an exemplary embodiment, the virtual carrier index may be corresponding to the G-RNTI and configured by RRC signaling from the network node.

In accordance with an exemplary embodiment, the virtual carrier index may be determined according to one of the following criteria:
the virtual carrier index is larger than all physical carrier indexes;
the virtual carrier index is smaller than all physical carrier indexes;
the virtual carrier index is larger than the associated physical carrier index, but smaller than other physical carrier indexes which are larger than the associated physical carrier index; and
the virtual carrier index is smaller than the associated physical carrier index, but larger than other physical carrier indexes which are smaller than the associated physical carrier index.

In accordance with an exemplary embodiment, when multicast traffics are scheduled for the terminal device at two or more physical carriers, each of the two or more physical carriers may be associated with a physical carrier index and a virtual carrier index. For a physical carrier index larger than another physical carrier index, its associated virtual carrier index may be larger than another virtual carrier index associated with the another physical carrier index.

In accordance with an exemplary embodiment, when one or more other multicast traffics are also scheduled at the physical carrier by different G-RNTIs, the physical carrier index of the physical carrier may also be associated with one or more other virtual carrier indexes corresponding to the one or more other multicast traffics. For a multicast traffic scheduled by a G-RNTI smaller than another G-RNTI, the corresponding virtual carrier index may be smaller than another virtual carrier index corresponding to another multicast traffic scheduled by the another G-RNTI.

In accordance with an exemplary embodiment, when the virtual carrier index is the same as the associated physical carrier index, each slot at the virtual carrier may have a virtual slot number associated with a physical slot number of a corresponding slot at the physical carrier.

In accordance with an exemplary embodiment, the virtual slot number may be determined according to one of the following criteria:
the virtual slot number is larger than all physical slot numbers;
the virtual slot number is smaller than all physical slot numbers;
the virtual slot number is larger than the associated physical slot number, but smaller than other physical slot numbers which are larger than the associated physical slot number; and
the virtual slot number is smaller than the associated physical slot number, but larger than other physical slot numbers which are smaller than the associated physical slot number.

In accordance with an exemplary embodiment, when there are two or more virtual carriers associated with a same physical carrier, for a virtual carrier scheduled with a G-RNTI smaller than another G-RNTI, its virtual slot number may be smaller than a virtual slot number of another virtual carrier scheduled with the another G-RNTI.

In accordance with an exemplary embodiment, when FDM between the unicast traffic and the multicast traffic in a same slot is not supported by the terminal device, the virtual slot number may be the same as its associated physical slot number.

In accordance with an exemplary embodiment, when FDM between different multicast traffics in a same slot is not supported by the terminal device, different virtual carriers associated with the different multicast traffics may have a same virtual slot number for the same slot.

In accordance with an exemplary embodiment, when concurrent reception of both the unicast traffic and the multicast traffic or both the multicast traffic and another multicast traffic is not supported by the terminal device in a same slot, the virtual carrier index may be the same as its associated physical carrier index.

In accordance with an exemplary embodiment, the feedback codebook may be constructed by concatenating codebooks separately constructed for the unicast traffic and the multicast traffic.

In accordance with an exemplary embodiment, the concatenation of two codebooks separately constructed for the unicast traffic and the multicast traffic may be based at least in part on a comparison between a C-RNTI associated with the unicast traffic and a G-RNTI associated with the multicast traffic. In an embodiment, the sequence of the two codebooks may be according to the comparison between a C-RNTI associated with the unicast traffic and a G-RNTI associated with the multicast traffic.

In accordance with an exemplary embodiment, the feedback codebook may include a first codebook for the unicast traffic followed by a second codebook for the multicast traffic.

In accordance with an exemplary embodiment, the second codebook may include one or more feedback bits, and a position of each of the one or more feedback bits may be based at least in part on a total number of feedback bits in the first codebook.

In accordance with an exemplary embodiment, when two or more codebooks for multicast traffics are concatenated in the feedback codebook, a codebook associated with a G-RNTI smaller than another G-RNTI may precede another codebook associated with the another G-RNTI.

FIG. 5B is a flowchart illustrating a method 520 according to some embodiments of the present disclosure. The method 520 illustrated in FIG. 5B may be performed by a network node or an apparatus communicatively coupled to the network node. In accordance with an exemplary embodiment, the network node may comprise a base station such as a gNB. The network node may be configured to provide various traffics (e.g., a unicast traffic, a multicast traffic, etc.) to one or more terminal devices such as UEs.

According to the exemplary method 520 illustrated in FIG. 5B, the network node may transmit a multicast traffic and/or a unicast traffic to a terminal device (e.g. the terminal device as described with respect to FIG. 5A), as shown in block 522. In accordance with an exemplary embodiment, the network node may receive feedback for the multicast traffic and/or the unicast traffic from the terminal device, according to a feedback codebook, as shown in block 524. As described with respect to FIG. 5A, the feedback codebook may be based at least in part on a first feedback codebook type (e.g. semi-static or dynamic feedback codebook type) for the multicast traffic and/or a second feedback codebook type (e.g. semi-static or dynamic feedback codebook type) for the unicast traffic.

It can be appreciated that the steps, operations and related configurations of the method 520 illustrated in FIG. 5B may correspond to the steps, operations and related configurations of the method 510 illustrated in FIG. 5A. It also can be appreciated that the feedback codebook as described with respect to FIG. 5B may correspond to the feedback codebook as described with respect to FIG. 5A. Thus, the feedback codebook as described with respect to the method 520 may have the same or similar contents and feature elements as the feedback codebook as described with respect to the method 510.

In accordance with an exemplary embodiment, when the multicast traffic is scheduled at a physical carrier by a G-RNTI, the network node can determine a virtual carrier index associated with a physical carrier index of the physical carrier. The virtual carrier index may be used to indicate that the multicast traffic is treated as being scheduled at a virtual carrier associated with the physical carrier.

In accordance with some exemplary embodiments, the virtual carrier index determined by the network node according to the method 520 may correspond to the virtual carrier index determined by the terminal device according to the method 510. It can be appreciated that the terminal device as described with respect to FIG. 5A and the network node as described with respect to FIG. 5B may determine the virtual carrier index based on the same or similar criterion. Similarly, it can be appreciated that the terminal device as described with respect to FIG. 5A and the network node as described with respect to FIG. 5B may determine a virtual slot number of a virtual carrier based on the same or similar criterion.

Various exemplary embodiments according to the present disclosure may enable a joint multicast and unicast HARQ feedback codebook. In accordance with an exemplary embodiment, the position of a HARQ bit in the HARQ feedback codebook may be determined, for example, according to a UE's capability of receiving traffic(s) and/or the feedback codebook type(s). For example, according to whether a semi-static HARQ feedback codebook or a dynamic HARQ feedback codebook is available for unicast/multicast transmission, and/or according to whether a UE can support simultaneous reception of unicast transmission and multicast transmission or not, a HARQ codebook with multicast feedback may be clearly determined for the UE in the case that there may be a multicast service of the UE. Application of various exemplary embodiments can enable the UE to send HARQ feedback for a multicast and/or unicast traffic in a more flexible and efficient way, so as to enhance network performance with improved resource utilization.

The various blocks shown in FIGS. 5A-5B may be viewed as method steps, and/or as operations that result from operation of computer program code, and/or as a plurality of coupled logic circuit elements constructed to carry out the associated function(s). The schematic flow chart diagrams described above are generally set forth as logical flow chart diagrams. As such, the depicted order and labeled steps are indicative of specific embodiments of the presented methods. Other steps and methods may be conceived that are equivalent in function, logic, or effect to one or more steps, or portions thereof, of the illustrated methods. Additionally, the order in which a particular method occurs may or may not strictly adhere to the order of the corresponding steps shown.

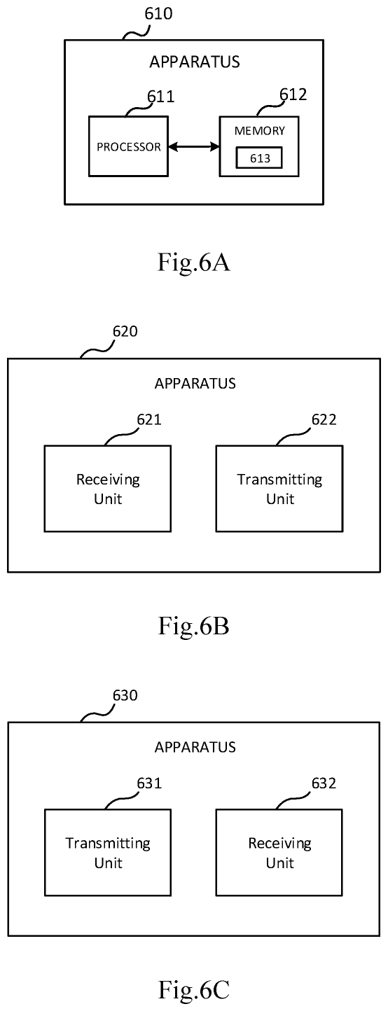

FIG. 6A is a block diagram illustrating an apparatus 610 according to various embodiments of the present disclosure. As shown in FIG. 6A, the apparatus 610 may comprise one or more processors such as processor 611 and one or more memories such as memory 612 storing computer program codes 613. The memory 612 may be non-transitory machine/processor/computer readable storage medium. In accordance with some exemplary embodiments, the apparatus 610 may be implemented as an integrated circuit chip or module that can be plugged or installed into a terminal device as described with respect to FIG. 5A, or a network node as described with respect to FIG. 5B. In such cases, the apparatus 610 may be implemented as a terminal device as described with respect to FIG. 5A, or a network node as described with respect to FIG. 5B.

In some implementations, the one or more memories 612 and the computer program codes 613 may be configured to, with the one or more processors 611, cause the apparatus 610 at least to perform any operation of the method as described in connection with FIG. 5A. In other implementations, the one or more memories 612 and the computer program codes 613 may be configured to, with the one or more processors 611, cause the apparatus 610 at least to perform any operation of the method as described in connection with FIG. 5B. Alternatively or additionally, the one or more memories 612 and the computer program codes 613 may be configured to, with the one or more processors 611, cause the apparatus 610 at least to perform more or less operations to implement the proposed methods according to the exemplary embodiments of the present disclosure.

FIG. 6B is a block diagram illustrating an apparatus 620 according to some embodiments of the present disclosure. As shown in FIG. 6B, the apparatus 620 may comprise a receiving unit 621 and a transmitting unit 622. In an exemplary embodiment, the apparatus 620 may be implemented in a terminal device such as a UE. The receiving unit 621 may be operable to carry out the operation in block 512, and the transmitting unit 622 may be operable to carry out the operation in block 514. Optionally, the receiving unit 621 and/or the transmitting unit 622 may be operable to carry out more or less operations to implement the proposed methods according to the exemplary embodiments of the present disclosure.

FIG. 6C is a block diagram illustrating an apparatus 630 according to some embodiments of the present disclosure. As shown in FIG. 6C, the apparatus 630 may comprise a transmitting unit 631 and a receiving unit 632. In an exemplary embodiment, the apparatus 630 may be implemented in a network node such as a base station. The transmitting unit 631 may be operable to carry out the operation in block 522, and the receiving unit 632 may be operable to carry out the operation in block 524. Optionally, the transmitting unit 631 and/or the receiving unit 632 may be operable to carry out more or less operations to implement the proposed methods according to the exemplary embodiments of the present disclosure.

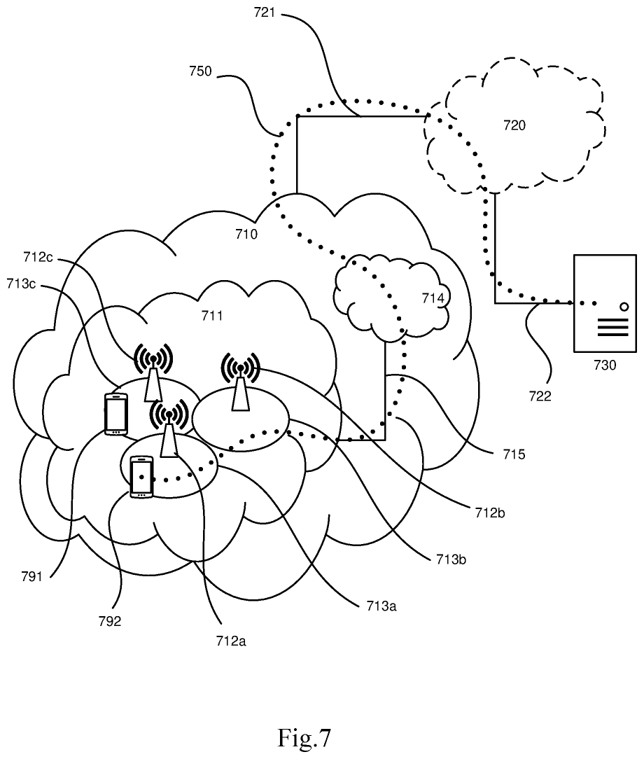

FIG. 7 is a block diagram illustrating a telecommunication network connected via an intermediate network to a host computer in accordance with some embodiments of the present disclosure.

With reference to FIG. 7, in accordance with an embodiment, a communication system includes a telecommunication network 710, such as a 3GPP-type cellular network, which comprises an access network 711, such as a radio access network, and a core network 714. The access network 711 comprises a plurality of base stations 712a, 712b, 712c, such as NBs, eNBs, gNBs or other types of wireless access points, each defining a corresponding coverage area 713a, 713b, 713c. Each base station 712a, 712b, 712c is connectable to the core network 714 over a wired or wireless connection 715. A first UE 791 located in a coverage area 713c is configured to wirelessly connect to, or be paged by, the corresponding base station 712c. A second UE 792 in a coverage area 713a is wirelessly connectable to the corresponding base station 712a. While a plurality of UEs 791, 792 are illustrated in this example, the disclosed embodiments are equally applicable to a situation where a sole UE is in the coverage area or where a sole UE is connecting to the corresponding base station 712.

The telecommunication network 710 is itself connected to a host computer 730, which may be embodied in the hardware and/or software of a standalone server, a cloud-implemented server, a distributed server or as processing resources in a server farm. The host computer 730 may be under the ownership or control of a service provider, or may be operated by the service provider or on behalf of the service provider. Connections 721 and 722 between the telecommunication network 710 and the host computer 730 may extend directly from the core network 714 to the host computer 730 or may go via an optional intermediate network 720. An intermediate network 720 may be one of, or a combination of more than one of, a public, private or hosted network; the intermediate network 720, if any, may be a backbone network or the Internet; in particular, the intermediate network 720 may comprise two or more sub-networks (not shown).

The communication system of FIG. 7 as a whole enables connectivity between the connected UEs 791, 792 and the host computer 730. The connectivity may be described as an over-the-top (OTT) connection 750. The host computer 730 and the connected UEs 791, 792 are configured to communicate data and/or signaling via the OTT connection 750, using the access network 711, the core network 714, any intermediate network 720 and possible further infrastructure (not shown) as intermediaries. The OTT connection 750 may be transparent in the sense that the participating communication devices through which the OTT connection 750 passes are unaware of routing of uplink and downlink communications. For example, the base station 712 may not or need not be informed about the past routing of an incoming downlink communication with data originating from the host computer 730 to be forwarded (e.g., handed over) to a connected UE 791. Similarly, the base station 712 need not be aware of the future routing of an outgoing uplink communication originating from the UE 791 towards the host computer 730.

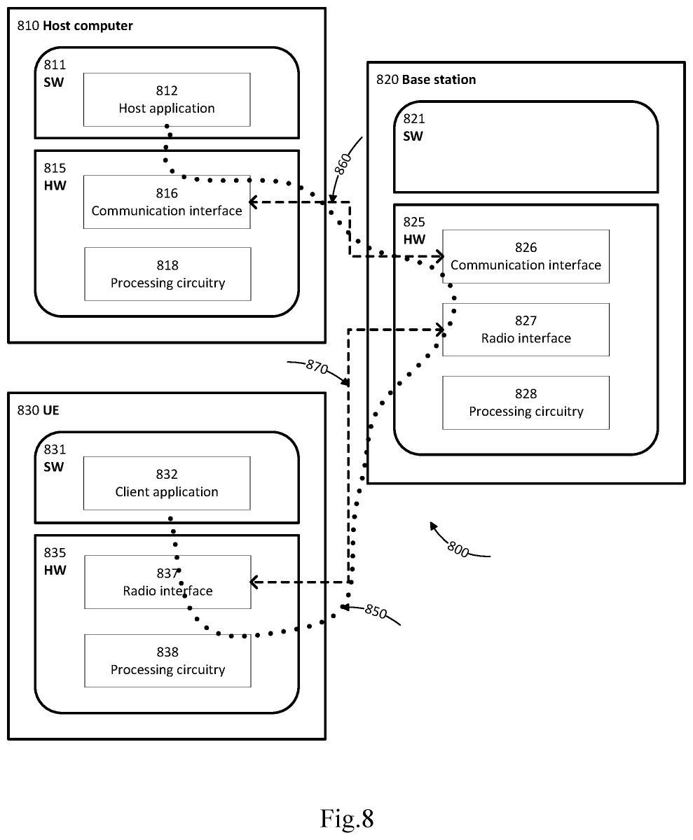

FIG. 8 is a block diagram illustrating a host computer communicating via a base station with a UE over a partially wireless connection in accordance with some embodiments of the present disclosure.

Example implementations, in accordance with an embodiment, of the UE, base station and host computer discussed in the preceding paragraphs will now be described with reference to FIG. 8. In a communication system 800, a host computer 810 comprises hardware 815 including a communication interface 816 configured to set up and maintain a wired or wireless connection with an interface of a different communication device of the communication system 800. The host computer 810 further comprises a processing circuitry 818, which may have storage and/or processing capabilities. In particular, the processing circuitry 818 may comprise one or more programmable processors, application-specific integrated circuits, field programmable gate arrays or combinations of these (not shown) adapted to execute instructions. The host computer 810 further comprises software 811, which is stored in or accessible by the host computer 810 and executable by the processing circuitry 818. The software 811 includes a host application 812. The host application 812 may be operable to provide a service to a remote user, such as UE 830 connecting via an OTT connection 850 terminating at the UE 830 and the host computer 810. In providing the service to the remote user, the host application 812 may provide user data which is transmitted using the OTT connection 850.

The communication system 800 further includes a base station 820 provided in a telecommunication system and comprising hardware 825 enabling it to communicate with the host computer 810 and with the UE 830. The hardware 825 may include a communication interface 826 for setting up and maintaining a wired or wireless connection with an interface of a different communication device of the communication system 800, as well as a radio interface 827 for setting up and maintaining at least a wireless connection 870 with the UE 830 located in a coverage area (not shown in FIG. 8) served by the base station 820. The communication interface 826 may be configured to facilitate a connection 860 to the host computer 810. The connection 860 may be direct or it may pass through a core network (not shown in FIG. 8) of the telecommunication system and/or through one or more intermediate networks outside the telecommunication system. In the embodiment shown, the hardware 825 of the base station 820 further includes a processing circuitry 828, which may comprise one or more programmable processors, application-specific integrated circuits, field programmable gate arrays or combinations of these (not shown) adapted to execute instructions. The base station 820 further has software 821 stored internally or accessible via an external connection.

The communication system 800 further includes the UE 830 already referred to. Its hardware 835 may include a radio interface 837 configured to set up and maintain a wireless connection 870 with a base station serving a coverage area in which the UE 830 is currently located. The hardware 835 of the UE 830 further includes a processing circuitry 838, which may comprise one or more programmable processors, application-specific integrated circuits, field programmable gate arrays or combinations of these (not shown) adapted to execute instructions. The UE 830 further comprises software 831, which is stored in or accessible by the UE 830 and executable by the processing circuitry 838. The software 831 includes a client application 832. The client application 832 may be operable to provide a service to a human or non-human user via the UE 830, with the support of the host computer 810. In the host computer 810, an executing host application 812 may communicate with the executing client application 832 via the OTT connection 850 terminating at the UE 830 and the host computer 810. In providing the service to the user, the client application 832 may receive request data from the host application 812 and provide user data in response to the request data. The OTT connection 850 may transfer both the request data and the user data. The client application 832 may interact with the user to generate the user data that it provides.

It is noted that the host computer 810, the base station 820 and the UE 830 illustrated in FIG. 8 may be similar or identical to the host computer 730, one of base stations 712a, 712b, 712c and one of UEs 791, 792 of FIG. 7, respectively. This is to say, the inner workings of these entities may be as shown in FIG. 8 and independently, the surrounding network topology may be that of FIG. 7.

In FIG. 8, the OTT connection 850 has been drawn abstractly to illustrate the communication between the host computer 810 and the UE 830 via the base station 820, without explicit reference to any intermediary devices and the precise routing of messages via these devices. Network infrastructure may determine the routing, which it may be configured to hide from the UE 830 or from the service provider operating the host computer 810, or both. While the OTT connection 850 is active, the network infrastructure may further take decisions by which it dynamically changes the routing (e.g., on the basis of load balancing consideration or reconfiguration of the network).

Wireless connection 870 between the UE 830 and the base station 820 is in accordance with the teachings of the embodiments described throughout this disclosure. One or more of the various embodiments improve the performance of OTT services provided to the UE 830 using the OTT connection 850, in which the wireless connection 870 forms the last segment. More precisely, the teachings of these embodiments may improve the latency and the power consumption, and thereby provide benefits such as lower complexity, reduced time required to access a cell, better responsiveness, extended battery lifetime, etc.

A measurement procedure may be provided for the purpose of monitoring data rate, latency and other factors on which the one or more embodiments improve. There may further be an optional network functionality for reconfiguring the OTT connection 850 between the host computer 810 and the UE 830, in response to variations in the measurement results. The measurement procedure and/or the network functionality for reconfiguring the OTT connection 850 may be implemented in software 811 and hardware 815 of the host computer 810 or in software 831 and hardware 835 of the UE 830, or both. In embodiments, sensors (not shown) may be deployed in or in association with communication devices through which the OTT connection 850 passes; the sensors may participate in the measurement procedure by supplying values of the monitored quantities exemplified above, or supplying values of other physical quantities from which the software 811, 831 may compute or estimate the monitored quantities. The reconfiguring of the OTT connection 850 may include message format, retransmission settings, preferred routing etc.; the reconfiguring need not affect the base station 820, and it may be unknown or imperceptible to the base station 820. Such procedures and functionalities may be known and practiced in the art. In certain embodiments, measurements may involve proprietary UE signaling facilitating the host computer 810's measurements of throughput, propagation times, latency and the like. The measurements may be implemented in that the software 811 and 831 causes messages to be transmitted, in particular empty or ‘dummy’ messages, using the OTT connection 850 while it monitors propagation times, errors etc.

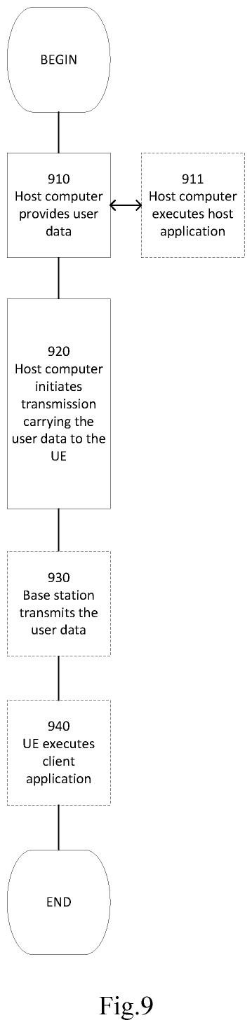

FIG. 9 is a flowchart illustrating a method implemented in a communication system, in accordance with an embodiment. The communication system includes a host computer, a base station and a UE which may be those described with reference to FIG. 7 and FIG. 8. For simplicity of the present disclosure, only drawing references to FIG. 9 will be included in this section. In step 910, the host computer provides user data. In substep 911 (which may be optional) of step 910, the host computer provides the user data by executing a host application. In step 920, the host computer initiates a transmission carrying the user data to the UE. In step 930 (which may be optional), the base station transmits to the UE the user data which was carried in the transmission that the host computer initiated, in accordance with the teachings of the embodiments described throughout this disclosure. In step 940 (which may also be optional), the UE executes a client application associated with the host application executed by the host computer.

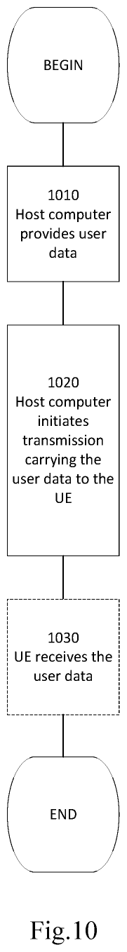

FIG. 10 is a flowchart illustrating a method implemented in a communication system, in accordance with an embodiment. The communication system includes a host computer, a base station and a UE which may be those described with reference to FIG. 7 and FIG. 8. For simplicity of the present disclosure, only drawing references to FIG. 10 will be included in this section. In step 1010 of the method, the host computer provides user data. In an optional substep (not shown) the host computer provides the user data by executing a host application. In step 1020, the host computer initiates a transmission carrying the user data to the UE. The transmission may pass via the base station, in accordance with the teachings of the embodiments described throughout this disclosure. In step 1030 (which may be optional), the UE receives the user data carried in the transmission.

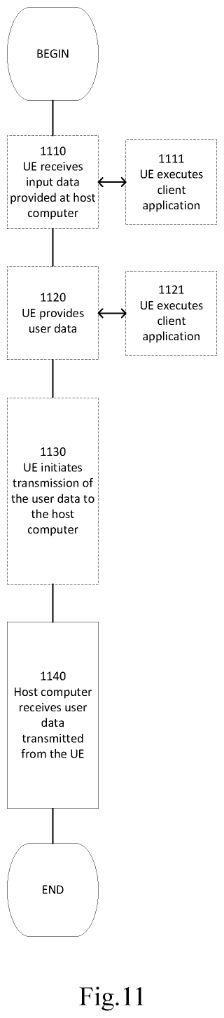

FIG. 11 is a flowchart illustrating a method implemented in a communication system, in accordance with an embodiment. The communication system includes a host computer, a base station and a UE which may be those described with reference to FIG. 7 and FIG. 8. For simplicity of the present disclosure, only drawing references to FIG. 11 will be included in this section. In step 1110 (which may be optional), the UE receives input data provided by the host computer. Additionally or alternatively, in step 1120, the UE provides user data. In substep 1121 (which may be optional) of step 1120, the UE provides the user data by executing a client application. In substep 1111 (which may be optional) of step 1110, the UE executes a client application which provides the user data in reaction to the received input data provided by the host computer. In providing the user data, the executed client application may further consider user input received from the user. Regardless of the specific manner in which the user data was provided, the UE initiates, in substep 1130 (which may be optional), transmission of the user data to the host computer. In step 1140 of the method, the host computer receives the user data transmitted from the UE, in accordance with the teachings of the embodiments described throughout this disclosure.

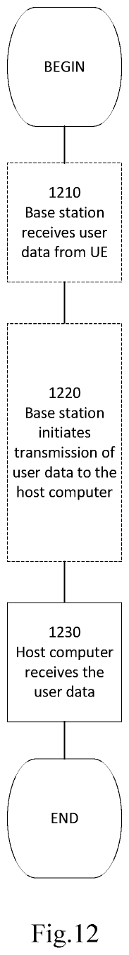

FIG. 12 is a flowchart illustrating a method implemented in a communication system, in accordance with an embodiment. The communication system includes a host computer, a base station and a UE which may be those described with reference to FIG. 7 and FIG. 8. For simplicity of the present disclosure, only drawing references to FIG. 12 will be included in this section. In step 1210 (which may be optional), in accordance with the teachings of the embodiments described throughout this disclosure, the base station receives user data from the UE. In step 1220 (which may be optional), the base station initiates transmission of the received user data to the host computer. In step 1230 (which may be optional), the host computer receives the user data carried in the transmission initiated by the base station.

According to some exemplary embodiments, there is provided a method implemented in a communication system which may include a host computer, a base station and a UE. The method may comprise providing user data at the host computer. Optionally, the method may comprise, at the host computer, initiating a transmission carrying the user data to the UE via a cellular network comprising the base station which may perform any step of the exemplary method 520 as describe with respect to FIG. 5B.

According to some exemplary embodiments, there is provided a communication system including a host computer. The host computer may comprise processing circuitry configured to provide user data, and a communication interface configured to forward the user data to a cellular network for transmission to a UE. The cellular network may comprise a base station having a radio interface and processing circuitry. The base station's processing circuitry may be configured to perform any step of the exemplary method 520 as describe with respect to FIG. 5B.

According to some exemplary embodiments, there is provided a method implemented in a communication system which may include a host computer, a base station and a UE. The method may comprise providing user data at the host computer. Optionally, the method may comprise, at the host computer, initiating a transmission carrying the user data to the UE via a cellular network comprising the base station. The UE may perform any step of the exemplary method 510 as describe with respect to FIG. 5A.

According to some exemplary embodiments, there is provided a communication system including a host computer. The host computer may comprise processing circuitry configured to provide user data, and a communication interface configured to forward user data to a cellular network for transmission to a UE. The UE may comprise a radio interface and processing circuitry. The UE's processing circuitry may be configured to perform any step of the exemplary method 510 as describe with respect to FIG. 5A.

According to some exemplary embodiments, there is provided a method implemented in a communication system which may include a host computer, a base station and a UE. The method may comprise, at the host computer, receiving user data transmitted to the base station from the UE which may perform any step of the exemplary method 510 as describe with respect to FIG. 5A.

According to some exemplary embodiments, there is provided a communication system including a host computer. The host computer may comprise a communication interface configured to receive user data originating from a transmission from a UE to a base station. The UE may comprise a radio interface and processing circuitry. The UE's processing circuitry may be configured to perform any step of the exemplary method 510 as describe with respect to FIG. 5A.

According to some exemplary embodiments, there is provided a method implemented in a communication system which may include a host computer, a base station and a UE. The method may comprise, at the host computer, receiving, from the base station, user data originating from a transmission which the base station has received from the UE. The base station may perform any step of the exemplary method 520 as describe with respect to FIG. 5B.

According to some exemplary embodiments, there is provided a communication system which may include a host computer. The host computer may comprise a communication interface configured to receive user data originating from a transmission from a UE to a base station. The base station may comprise a radio interface and processing circuitry. The base station's processing circuitry may be configured to perform any step of the exemplary method 520 as describe with respect to FIG. 5B.

In general, the various exemplary embodiments may be implemented in hardware or special purpose chips, circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, random access memory (RAM), etc. As will be appreciated by one of skill in the art, the function of the program modules may be combined or distributed as desired in various embodiments. In addition, the function may be embodied in whole or partly in firmware or hardware equivalents such as integrated circuits, field programmable gate arrays (FPGA), and the like.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

1. A method performed by a terminal device, comprising:
receiving a multicast traffic and/or a unicast traffic from a network node; and
transmitting feedback for the multicast traffic and/or the unicast traffic to the network node, according to a feedback codebook, wherein the feedback codebook is based at least in part on a first feedback codebook type for the multicast traffic and/or a second feedback codebook type for the unicast traffic.

2. The method according to claim 1, wherein the first feedback codebook type and the second feedback codebook type are both dynamic feedback codebook types; or
wherein at least one of the first feedback codebook type and the second feedback codebook type is a semi-static feedback codebook type.

3. (canceled)

4. The method according to claim 1, wherein the feedback codebook includes a first set of bits and/or a second set of bits, and wherein the first set of bits include one or more feedback bits determined for the multicast traffic according to the first feedback codebook type, and the second set of bits include one or more feedback bits determined for the unicast traffic according to the second feedback codebook type.

5. The method according to claim 4, wherein the first set of bits and/or the second set of bits are located in the feedback codebook according to a first criterion.

6. The method according to claim 5, wherein the first criterion includes that:
all feedback bits of transmissions at a first carrier precede all feedback bits of transmissions at a second carrier, wherein an index of the first carrier is smaller than an index of the second carrier; or
wherein the first criterion includes that:
a feedback bit of a multicast transmission at a first slot of a first carrier follows a feedback bit of a unicast transmission at the first slot of the first carrier; or
wherein the first criterion includes that:
a feedback bit of a multicast transmission at a first slot of a first carrier precedes a feedback bit of a unicast transmission at the first slot of the first carrier.

7. (canceled)

8. (canceled)

9. The method according to claim 5, wherein the first criterion includes that:
all feedback bits of transmissions at a first slot of a first carrier precede all feedback bits of transmissions at a second slot of the first carrier, wherein an index of the first slot is smaller than an index of the second slot.

10. The method according to claim 6, wherein the first criterion further includes that:
all feedback bits of multicast transmissions at the first carrier follow all feedback bits of unicast transmissions at the first carrier.

11. The method according to claim 5, wherein the first criterion includes that:
all feedback bits of multicast transmissions at a first carrier precede all feedback bits of unicast transmissions at the first carrier, while following all feedback bits of transmissions at a third carrier, wherein an index of the first carrier is larger than an index of the third carrier; or
wherein the first criterion includes that:
all feedback bits of multicast transmissions precede all feedback bits of unicast transmissions; or
wherein the first criterion includes that:
all feedback bits of multicast transmissions follow all feedback bits of unicast transmissions.

12. (canceled)

13. (canceled)

14. The method according to claim 5, wherein the first criterion further includes that:
all feedback bits of multicast transmissions at a first carrier precede all feedback bits of multicast transmissions at a second carrier, wherein an index of the first carrier is smaller than an index of the second carrier; and/or
a feedback bit of a multicast transmission at a first slot of a first carrier precedes a feedback bit of a multicast transmission at a second slot of the first carrier, wherein an index of the first slot is smaller than an index of the second slot.

15. (canceled)

16. (canceled)

17. The method according to claim 2, wherein the feedback codebook has a same number of one or more feedback bits as a semi-static feedback codebook which is determined for the multicast traffic or the unicast traffic.

18. The method according to claim 17, wherein the one or more feedback bits are located in the feedback codebook according to a second criterion.

19. The method according to claim 18, wherein the second criterion includes that:
a feedback bit of a multicast transmission is located in the feedback codebook according to a slot and a carrier which are corresponding to the multicast transmission; and/or
a feedback bit of a unicast transmission is located in the feedback codebook according to a slot and a carrier which are corresponding to the unicast transmission.

20. The method according to claim 1, wherein when the multicast traffic is scheduled at a physical carrier by a group-radio network temporary identifier, G-RNTI, the method further comprises:
determining a virtual carrier index associated with a physical carrier index of the physical carrier, wherein the virtual carrier index is used to indicate that the multicast traffic is treated as being scheduled at a virtual carrier associated with the physical carrier.

21. The method according to claim 20, wherein the virtual carrier index is corresponding to the G-RNTI and configured by radio resource control signaling from the network node; or
wherein the virtual carrier index is determined according to one of the following criteria:
the virtual carrier index is larger than all physical carrier indexes;
the virtual carrier index is smaller than all physical carrier indexes;
the virtual carrier index is larger than the associated physical carrier index, but smaller than other physical carrier indexes which are larger than the associated physical carrier index; and
the virtual carrier index is smaller than the associated physical carrier index, but larger than other physical carrier indexes which are smaller than the associated physical carrier index.

22. (canceled)

23. The method according to claim 1, wherein when multicast traffics are scheduled for the terminal device at two or more physical carriers, each of the two or more physical carriers is associated with a physical carrier index and a virtual carrier index, and wherein for a physical carrier index larger than another physical carrier index, its associated virtual carrier index is larger than another virtual carrier index associated with the another physical carrier index; or
when one or more other multicast traffics are also scheduled at the physical carrier by different G-RNTIs, the physical carrier index of the physical carrier is also associated with one or more other virtual carrier indexes corresponding to the one or more other multicast traffics, and wherein for a multicast traffic scheduled by a G-RNTI smaller than another G-RNTI, the corresponding virtual carrier index is smaller than another virtual carrier index corresponding to another multicast traffic scheduled by the another G-RNTI; or
wherein when the virtual carrier index is the same as the associated physical carrier index, each slot at the virtual carrier has a virtual slot number associated with a physical slot number of a corresponding slot at the physical carrier.

24. (canceled)

25. (canceled)

26. The method according to claim 23, wherein the virtual slot number is determined according to one of the following criteria:
the virtual slot number is larger than all physical slot numbers;
the virtual slot number is smaller than all physical slot numbers;
the virtual slot number is larger than the associated physical slot number, but smaller than other physical slot numbers which are larger than the associated physical slot number; and
the virtual slot number is smaller than the associated physical slot number, but larger than other physical slot numbers which are smaller than the associated physical slot number.

27. The method according to claim 23, wherein when there are two or more virtual carriers associated with a same physical carrier, for a virtual carrier scheduled with a G-RNTI smaller than another G-RNTI, its virtual slot number is smaller than a virtual slot number of another virtual carrier scheduled with the another G-RNTI; or
wherein when frequency division multiplexing, FDM, between the unicast traffic and the multicast traffic in a same slot is not supported by the terminal device, the virtual slot number is the same as its associated physical slot number; or
wherein when FDM between different multicast traffics in a same slot is not supported by the terminal device, different virtual carriers associated with the different multicast traffics have a same virtual slot number for the same slot.

28. (canceled)

29. (canceled)

30. The method according to claim 23, wherein when concurrent reception of both the unicast traffic and the multicast traffic or both the multicast traffic and another multicast traffic is not supported by the terminal device in a same slot, the virtual carrier index is the same as its associated physical carrier index.

31. The method according to claim 1, wherein the feedback codebook is constructed by concatenating codebooks separately constructed for the unicast traffic and the multicast traffic.

32. The method according to claim 31, wherein the concatenation of the codebooks separately constructed for the unicast traffic and the multicast traffic is based at least in part on a comparison between a cell-radio network temporary identifier, C-RNTI, associated with the unicast traffic and a G-RNTI associated with the multicast traffic.

33. The method according to claim 31, wherein the feedback codebook includes a first codebook for the unicast traffic followed by a second codebook for the multicast traffic; or
wherein the second codebook includes one or more feedback bits, and a position of each of the one or more feedback bits is based at least in part on a total number of feedback bits in the first codebook.

34. (canceled)

35. The method according to claim 31, wherein when two or more codebooks for multicast traffics are concatenated in the feedback codebook, a codebook associated with a G-RNTI smaller than another G-RNTI precedes another codebook associated with the another G-RNTI.

36. A terminal device, comprising:
one or more processors; and
one or more memories comprising computer program codes,
the one or more memories and the computer program codes configured to, with the one or more processors, cause the terminal device at least to:
receive a multicast traffic and/or a unicast traffic from a network node; and
transmit feedback for the multicast traffic and/or the unicast traffic to the network node, according to a feedback codebook, wherein the feedback codebook is based at least in part on a first feedback codebook type for the multicast traffic and/or a second feedback codebook type for the unicast traffic.

37. (canceled)

38. (canceled)

39. A method performed by a network node, comprising:
transmitting a multicast traffic and/or a unicast traffic to a terminal device; and
receiving feedback for the multicast traffic and/or the unicast traffic from the terminal device, according to a feedback codebook, wherein the feedback codebook is based at least in part on a first feedback codebook type for the multicast traffic and/or a second feedback codebook type for the unicast traffic.

40-73. (canceled)

74. A network node, comprising:
one or more processors; and
one or more memories comprising computer program codes,
the one or more memories and the computer program codes configured to, with the one or more processors, cause the network node at least to:
transmit a multicast traffic and/or a unicast traffic to a terminal device; and
receive feedback for the multicast traffic and/or the unicast traffic from the terminal device, according to a feedback codebook, wherein the feedback codebook is based at least in part on a first feedback codebook type for the multicast traffic and/or a second feedback codebook type for the unicast traffic.

75-92. (canceled)
